(19) United States
(12) Patent Application Publication
(10) Pub. No.: US 2026/0292139 A1
(43) Pub. Date: Sep. 24, 2026

(54) IMAGE ENCODING/DECODING METHOD USING TEMPLATE MATCHING, METHOD FOR TRANSMITTING BITSTREAM, AND RECORDING MEDIUM HAVING BITSTREAM STORED THEREIN

(71) Applicant: LG Electronics Inc., Seoul (KR)

(72) Inventors: Hyeong Moon JANG, Seoul (KR); Nae Ri PARK, Seoul (KR); Jung Hak NAM, Seoul (KR); Yongjo AHN, Seoul (KR)

(21) Appl. No.: 19/474,083

(22) PCT Filed: Apr. 25, 2024
(86) PCT No.: PCT/KR2024/005621

§ 371 Date: Oct. 9, 2025

Related U.S. Application Data
(60) Provisional application No. 63/461,888, filed on Apr. 25, 2023.

(30) Foreign Application Priority Data
Jun. 30, 2023 (KR) 10-2023-0085089

(51) Int. Cl. H04N 19/105; H04N 19/159; H04N 19/176; H04N 19/196; H04N 19/513

(52) U.S. Cl. CPC H04N 19/105; H04N 19/159; H04N 19/176; H04N 19/196; H04N 19/521

(57) ABSTRACT

An image encoding/decoding method, a method for transmitting a bitstream, and a computer-readable recording medium for storing a bitstream are provided. An image decoding method according to the present disclosure, as an image decoding method performed by an image decoding device, may comprise the steps of: determining a prediction mode of a current block; generating an inter prediction block of the current block on the basis that the prediction mode of the current block is an inter prediction mode; and restoring the current block on the basis of the inter prediction block, wherein the inter prediction block is generated on the basis of prediction candidates of a prediction candidate list, and the prediction candidate list includes two or more prediction candidates among a merge prediction candidate, a merge with motion vector difference (MMVD) prediction candidate, a combined inter-intra prediction (CIIP), a multi-hypothesis prediction, an affine merge, a subblock-based temporal motion vector prediction (SbTMVP), and a geometric partitioning mode (GPM) merge prediction candidate.

### TECHNICAL FIELD

The present disclosure relates to an image encoding/decoding method using template matching (TM), a method for transmitting a bitstream and a recording medium for storing a bitstream. More specifically, it relates to a method for performing inter prediction using template matching.

### BACKGROUND ART

Recently, the demand for high-resolution and high-quality images, such as High Definition (HD) images and Ultra High Definition (UHD) images, has been increasing in various fields. As image data becomes high-resolution and high-quality, the amount of transmitted information or bit rate increases relative to conventional image data. The increase in transmitted information or bit rate amount leads to an increase in transmission costs and storage costs.

Accordingly, a high-efficiency image compression technology is required to effectively transmit, store, and reproduce the information of high-resolution and high-quality images.

### DISCLOSURE

### Technical Problem

The present disclosure is to provide an image encoding/decoding method and apparatus with improved encoding/decoding efficiency.

In addition, the present disclosure is to provide a method for performing inter prediction using template matching.

In addition, the present disclosure is to provide a method for constructing a generalized, i.e., complex merge candidate list based on template matching in the process of constructing a prediction candidate list during inter prediction.

In addition, the present disclosure is to provide a single merge candidate list including a merge candidate derived in various ways.

In addition, the present disclosure is to provide a method for deriving motion information and generating a prediction block by referring to the candidate of a generalized merge candidate list.

In addition, the present disclosure is to provide a non-transitory computer-readable recording medium for storing a bitstream generated by the image encoding method according to the present disclosure.

In addition, the present disclosure is to provide a non-transitory computer-readable recording medium for storing a bitstream which is received and decoded by the image decoding apparatus according to the present disclosure and used for image reconstruction.

In addition, the present disclosure is to provide a method for transmitting a bitstream which is generated by the image encoding method according to the present disclosure.

The technical problems to be achieved in the present disclosure are not limited to the technical problems described above, and other technical problems not described may be clearly understood by those of ordinary skill in the art from the following descriptions.

### Technical Solution

An image decoding method performed by an image decoding apparatus according to an aspect of the present disclosure includes determining a prediction mode of a current block, generating an inter prediction block of the current block based on the prediction mode of the current block being an inter prediction mode and reconstructing the current block based on the inter prediction block, wherein the inter prediction block is generated based on a prediction candidate of a prediction candidate list, and the prediction candidate list may include at least two prediction candidates among a merge prediction candidate, a merge with motion vector difference (MMVD) prediction candidate, combined inter-intra prediction (CIIP), multi-hypothesis prediction, affine merge, subblock-based temporal motion vector prediction (SbTMVP) or a geometric partitioning mode (GPM) merge prediction candidate.

Meanwhile, according to an embodiment of the present disclosure, the prediction candidate list may be derived based on a prediction candidate list usage flag.

Meanwhile, according to an embodiment of the present disclosure, the prediction candidate list usage flag may be obtained from a bitstream.

Meanwhile, according to an embodiment of the present disclosure, the prediction candidate may be selected based on a prediction candidate index.

Meanwhile, according to an embodiment of the present disclosure, the prediction candidate index may be signaled from a bitstream.

Meanwhile, according to an embodiment of the present disclosure, the prediction candidate of the prediction candidate list may be ordered according to an error value derived based on a difference value between a pixel value of a template area of a reference picture and a neighboring pixel of the current block.

Meanwhile, according to an embodiment of the present disclosure, the error value may be derived based on at least one of the sum of absolute difference (SAD) or the mean-reduced SAD (MR-SAD).

Meanwhile, according to an embodiment of the present disclosure, based on the CIIP prediction candidate being included in the prediction candidate list, an error value for the CHIP prediction candidate may be derived based on a value obtained by weighted averaging pixel values of template areas of a reference picture and an intra prediction block.

Meanwhile, according to an embodiment of the present disclosure, based on the GPM prediction candidate being included in the prediction candidate list, an error value for the GPM prediction candidate may be derived based on a value obtained by weighted averaging pixel values of template areas of a plurality of inter prediction blocks.

An image encoding method performed by an image encoding apparatus according to an aspect of the present disclosure includes determining a prediction mode of a current block as an inter prediction mode, generating a prediction block of the current block based on the inter prediction mode and reconstructing the current block based on the prediction block, wherein the prediction block is generated based on a prediction candidate of a prediction candidate list, and the prediction candidate list may include at least two prediction candidates among a merge prediction candidate, a merge with motion vector difference (MMVD) prediction candidate, combined inter-intra prediction (CIIP), multi-hypothesis prediction, affine merge, subblock-based temporal motion vector prediction (SbTMVP) or a geometric partitioning mode (GPM) merge prediction candidate.

Meanwhile, according to an embodiment of the present disclosure, information on the prediction candidate list may be encoded into a bitstream.

Meanwhile, according to an embodiment of the present disclosure, information on the prediction candidate list may include a prediction candidate list usage flag and a prediction candidate index.

A computer-readable recording medium according to another aspect of the present disclosure may store a bitstream generated by the image encoding method or apparatus of the present disclosure.

A transmission method according to another aspect of the present disclosure may transmit a bitstream generated by the image encoding method or apparatus of the present disclosure.

The features briefly summarized above for the present disclosure are merely an exemplary aspect of a detailed description of the present disclosure described below, and do not limit the scope of the present disclosure.

### Advantageous Effects

According to the present disclosure, an image encoding/decoding method and apparatus with improved encoding/decoding efficiency may be provided.

In addition, according to the present disclosure, a method for performing inter prediction using template matching may be provided.

In addition, according to the present disclosure, coding efficiency may be improved through a single merge candidate list including a merge candidate derived in various ways.

In addition, according to the present disclosure, the amount of bits required may be reduced by using a single complex merge candidate list.

In addition, according to the present disclosure, a non-transitory computer-readable recording medium for storing a bitstream generated by the image encoding method according to the present disclosure may be provided.

In addition, according to the present disclosure, a non-transitory computer-readable recording medium for storing a bitstream which is received and decoded by the image decoding apparatus according to the present disclosure and used for image reconstruction may be provided.

In addition, according to the present disclosure, a method for transmitting a bitstream generated by the image encoding method may be provided.

The effects obtainable from the present disclosure are not limited to the effects described above, and other effects not described may be clearly understood by those of ordinary skill in the art from the following descriptions.

### DESCRIPTION OF DRAWINGS

FIG. 1 shows a schematic diagram of a video coding system to which an embodiment according to the present disclosure may be applied.

FIG. 2 shows a schematic diagram of an image encoding apparatus to which an embodiment according to the present disclosure may be applied.

FIG. 3 shows a schematic diagram of an image decoding apparatus to which an embodiment according to the present disclosure may be applied.

FIG. 4 is a diagram schematically representing an inter predictor of an image encoding apparatus.

FIG. 5 is a flowchart representing a method for encoding an image based on inter prediction.

FIG. 6 is a diagram schematically representing an inter predictor of an image decoding apparatus.

FIG. 7 is a flowchart representing a method for decoding an image based on inter prediction.

FIG. 8 is a flowchart representing an inter prediction method.

FIG. 9 is a diagram for describing a template matching-based encoding/decoding method according to the present disclosure.

FIG. 10 is a diagram illustrating the template of a current block and reference samples of a template within reference pictures.

FIG. 11 is a diagram for describing a method for specifying a template by using motion information of a sub-block.

FIG. 12 is a diagram for describing an example of a method for calculating a template matching error according to an embodiment of the present disclosure.

FIG. 13 is a diagram for describing an example of a method for calculating a template matching error according to an embodiment of the present disclosure.

FIG. 14 is a diagram for describing an example of a method for calculating a template matching error according to an embodiment of the present disclosure.

FIG. 15 is a diagram for describing an example of a method for calculating a template matching error according to an embodiment of the present disclosure.

FIG. 16 is a diagram for describing an example of a method for calculating a template matching error according to an embodiment of the present disclosure.

FIG. 17 is a diagram for describing an example of a method for calculating a template matching error according to an embodiment of the present disclosure.

FIG. 18 is a diagram for describing an example of a method for calculating a template matching error according to an embodiment of the present disclosure.

FIGS. 19 to 22 are diagrams for describing a process for constructing a generalized merge prediction candidate list according to an embodiment of the present disclosure.

FIG. 23 is a diagram for describing an image decoding method according to an embodiment of the present disclosure.

FIG. 24 is a diagram for describing an image encoding method according to an embodiment of the present disclosure.

FIG. 25 shows an exemplary diagram of a content streaming system to which an embodiment of the present disclosure may be applied.

### MODE FOR INVENTION

Hereinafter, embodiments of the present disclosure will be described in detail by referring to the attached drawings for those of ordinary skill in the art to easily implement them. However, the present disclosure may be implemented in various different forms and is not limited to the embodiments described herein.

In describing embodiments of the present disclosure, detailed explanations of well-known configurations or functions are omitted when they are deemed to obscure the main point of the present disclosure. Additionally, parts irrelevant to the description of the present disclosure are omitted from the drawings, and similar reference numerals have been assigned to similar parts.

In the present disclosure, when a certain component is described as being “connected,” “coupled,” or “linked” to another component, this may include not only a direct connection but also an indirect connection where another component may exist in the middle. Additionally, when a certain component is described as “including” or “having” another component, this means that, unless explicitly stated otherwise, it does not exclude other components but may further include additional components.

In the present disclosure, the terms first, second, etc. are used solely for the purpose of distinguishing one component from another and do not limit the order or importance of the components unless explicitly stated otherwise. Accordingly, a first component in one embodiment may be referred to as a second component in another embodiment, and similarly, a second component in one embodiment may be referred to as a first component in another embodiment within the range of the present disclosure.

In the present disclosure, distinguishable components are described to clearly explain their respective characteristics and do not necessarily mean that the components are separate. In other words, a plurality of components may be integrated into a single hardware or software unit, or a single component may be distributed across multiple hardware or software units. Accordingly, without explicitly describing them, such integrated or distributed embodiments are also included in the range of the present disclosure.

In the present disclosure, the components described in various embodiments do not necessarily mean essential components, and some may be optional components. Accordingly, embodiments composed of a subset of the components described in one embodiment are also included in the range of the present disclosure. Additionally, embodiments that include additional components beyond those described in various embodiments are also included in the range of the present disclosure.

The present disclosure relates to the encoding and decoding of images, and the terms used herein may have the ordinary meanings commonly used in the field of technology to which this disclosure belongs unless the terms are newly defined in the present disclosure.

In the present disclosure, “picture” generally refers to a unit representing a single image at a specific point in time. A slice/tile is an encoding unit that constitutes a part of a picture, and a picture may be composed of one or more slices/tiles. Additionally, a slice/tile may include one or more coding tree units (CTUs).

In the present disclosure, “pixel” or “pel” may refer to the smallest unit that constitutes one picture (or image). Additionally, the term “sample” may be used as a corresponding term for a pixel. A sample may generally represent a pixel or the value of a pixel and may indicate only the pixel/pixel value of a luma component or only the pixel/pixel value of a chroma component.

In the present disclosure, “unit” may refer to a basic unit of image processing. A unit may include at least one of a specific area of a picture or information related to the area. Depending on the context, the term “unit” may be used interchangeably with “sample array,” “block,” “area,” etc. In general, an M×N block may include a set (or array) of samples (or a sample array) or a set (or array) of transform coefficients, consisting of M columns and N rows.

In the present disclosure, the term “current block” may refer to one of “current coding block”, “current coding unit”, “encoding target block”, “decoding target block”, or “processing target block”. When prediction is performed, “current block” may refer to “current prediction block” or “prediction target block”. When transform (inverse transform)/quantization (dequantization) is performed, “current block” may refer to “current transform block” or “transform target block”. When filtering is performed, “current block” may refer to “filtering target block”.

In the present disclosure, unless explicitly stated as a chroma block, the term “current block” may refer to a block that includes both a luma component block and a chroma component block or may refer to “the luma block of the current block”. The luma component block of the current block may be explicitly expressed with terms such as “luma block” or “current luma block”, clearly indicating it as a luma component block. Additionally, the chroma component block of the current block may be explicitly expressed with terms such as “chroma block” or “current chroma block”, clearly indicating it as a chroma component block.

In the present disclosure, “/” and “,” may refer to “and/or”. For example, “A/B” and “A, B” may refer to “A and/or B”. Additionally, “A/B/C” and “A, B, C” may refer to “at least one of A, B, and/or C”.

In the present disclosure, “or” may refer to “and/or”. For example, “A or B” may mean 1) “A” only, 2) “B” only, or 3) “A and B.” Alternatively, in the present disclosure, “or” may also mean “additionally or alternatively”.

### Overview of the Video Coding System

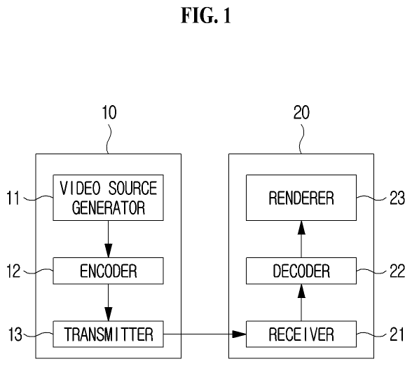

FIG. 1 shows a schematic diagram of a video coding system to which an embodiment according to the present disclosure may be applied.

A video coding system according to an embodiment may include an encoder apparatus 10 and a decoder apparatus 20. The encoder apparatus 10 may transmit encoded video and/or image information or data to the decoder apparatus 20 through a digital storage medium or network in the form of a file or streaming.

An encoder apparatus 10 according to an embodiment may include a video source generator 11, an encoder 12, and a transmitter 13. A decoder apparatus 20 according to an embodiment may include a receiver 21, a decoder 22, and a renderer 23. The encoder 12 may be referred to as a video/image encoder, and the decoder 22 may be referred to as a video/image decoder. The transmitter 13 may be included in the encoder 12. The receiver 21 may be included in the decoder 22. The renderer 23 may include a display, and the display may be configured as a separate device or external component.

The video source generator 11 may obtain a video/an image through a process of capturing, synthesizing, or generating a video/an image. The video source generator 11 may include a video/an image capture device and/or a video/an image generation device. The video/image capture device may include, for example, one or more cameras, a video/an image archive containing previously captured video/image, etc. The video/image generation device includes, for example, a computer, tablet, or smartphone, and may (electronically) generate a video/an image. For example, virtual video/image may be generated through a computer, etc., and in this case, the video/image capturing process may be replaced by the process of generating related data.

The encoder 12 may encode the input video/image. The encoder 12 may perform a series of procedures such as prediction, transform, quantization, etc. for compression and encoding efficiency. The encoder 12 may output the encoded data (encoded video/image information) in the form of a bitstream.

The transmitter 13 may obtain the encoded video/image information or data output in the form of a bitstream and transmit it to the receiver 21 of the decoder apparatus 20 or another external object through a digital storage medium or network, in the form of a file or streaming. The digital storage medium may include various storage media such as USB, SD, CD, DVD, Blu-ray, HDD, SSD, etc. The transmitter 13 may include an element for generating media files through a predetermined file format and element for transmission over broadcast/communication networks. The transmitter 13 may be provided as a separate transmission apparatus from the encoding apparatus 12, in which case the transmission apparatus may include at least one processor for obtaining the encoded video/image information or data in bitstream form and a transmitter for delivering it in the form of file or streaming. The receiver 21 may extract/receive the bitstream from the storage medium or network and transmit it to decoder 22.

The decoder 22 may decode the video/image by performing a series of procedures such as dequantization, inverse transform, prediction, etc. corresponding to the operations of the encoder 12.

The renderer 23 may render the decoded video/image. The rendered video/image may be displayed through the display unit.

### Overview of the Image Encoding Apparatus

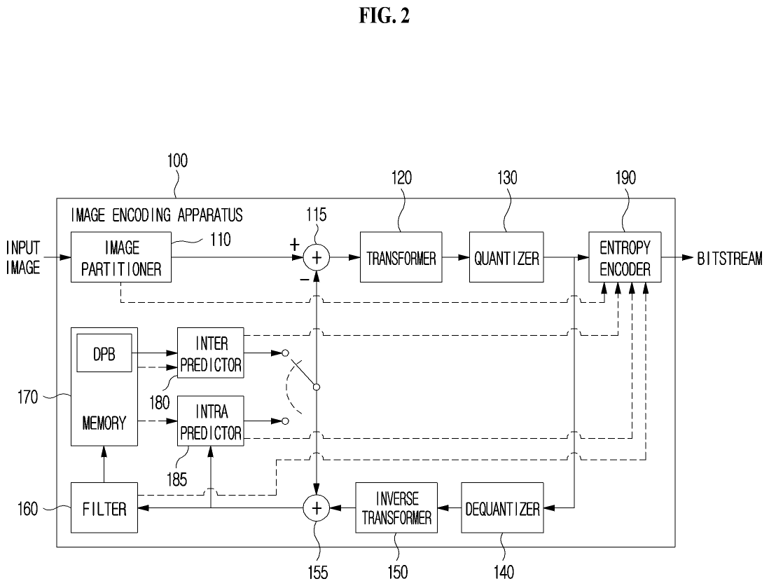

FIG. 2 shows a schematic diagram of an image encoding apparatus to which an embodiment according to the present disclosure may be applied.

As described in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter predictor 180, an intra predictor 185, and an entropy encoder 190. The inter predictor 180 and the intra predictor 185 may collectively be referred to as a “predictor.” The transformer 120, the quantizer 130, the dequantizer 140, and the inverse transformer 150 may be included in a residual processor. The residual processor may further include the subtractor 115.

All or at least some of the multiple components constituting the image encoding apparatus 100 may be implemented as a single hardware component (i.e., an encoder or a processor), depending on the embodiment. Additionally, the memory 170 may include a decoded picture buffer (DPB) and may be implemented by a digital storage medium.

The image partitioner 110 may partition the input image (or picture, frame) input to the image encoding apparatus 100 into at least one processing unit. As an example, the processing unit may be referred to as a coding unit (CU). A coding unit may be obtained by recursively partitioning a coding tree unit (CTU) or a largest coding unit (LCU) according to a quad-tree, binary-tree, or ternary-tree (QT/BT/TT) structure. For example, a coding unit may be divided into a deeper-depth coding unit based on a quad-tree structure, a binary-tree structure, and/or a ternary-tree structure. For partitioning a coding unit, the quad-tree structure may be applied first, followed by the binary-tree structure and/or the ternary-tree structure. The coding procedure according to the present disclosure may be performed based on the final coding unit, which is not further partitioned. The largest coding unit may be used directly as the final coding unit, or a deeper-depth coding unit obtained by partitioning the largest coding unit may be used as the final coding unit. Here, the coding procedure may include a procedure such as prediction, transform, and/or reconstruction, which will be described later. As another example, the processing unit for the coding procedure may be a prediction unit (PU) or a transform unit (TU). The prediction unit and the transform unit may each be divided or partitioned from the final coding unit. The prediction unit may be a unit for sample prediction, and the transform unit may be a unit for deriving a transform coefficient and/or deriving a residual signal from a transform coefficient.

The predictor (inter predictor 180 or intra predictor 185) may perform prediction for a target block (current block) and generate a predicted block that includes prediction samples for the current block. The predictor may determine whether intra prediction or inter prediction is applied to the current block or coding unit (CU). The predictor may generate various information related to the prediction of the current block and transmit it to the entropy encoder 190. The prediction-related information may be encoded by the entropy encoder 190 and may be output in the form of a bitstream.

The intra predictor 185 may predict the current block by referring to samples within the current picture. The referenced samples may be located in the neighboring area of the current block or may be located farther away, depending on the intra prediction mode and/or intra prediction method. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes, depending on the granularity of the prediction direction. However, this is an example, and a greater or fewer number of directional prediction modes may be used depending on the configuration. The intra predictor 185 may also determine the prediction mode applied to the current block by using the prediction mode applied to neighboring block.

The inter predictor 180 may derive a predicted block for the current block based on a reference block (reference sample array) specified by a motion vector on a reference picture. To reduce the amount of motion information transmitted in the inter prediction mode, motion information may be predicted at the block, sub-block, or sample level based on the correlation of motion information between the neighboring block and the current block. The motion information may include a motion vector and a reference picture index. The motion information may further include information on the inter prediction direction (i.e. L0 prediction, L1 prediction, Bi prediction, etc.). In inter prediction, neighboring block may include spatial neighboring block present within the current picture and temporal neighboring block present in the reference picture. The reference picture containing the reference block and the reference picture containing the temporal neighboring block may be the same or different. The temporal neighboring block may be referred to as a collocated reference block or a collocated coding unit (colCU). The reference picture containing the temporal neighboring block may be referred to as a collocated picture (colPic). For example, the inter predictor 180 may construct a motion information candidate list based on neighboring blocks and generate information indicating which candidate is used to derive the motion vector and/or reference picture index of the current block. Inter prediction may be performed based on various prediction modes, and for example, in the skip mode and merge mode, the inter predictor 180 may use the motion information of neighboring block as the motion information of the current block. In skip mode, unlike merge mode, residual signal may not be transmitted. In the motion vector prediction (MVP) mode, the motion vector of a neighboring block may be used as a motion vector predictor, and the motion vector of the current block may be signaled by encoding the motion vector difference and an indicator for the motion vector predictor. The motion vector difference may refer to the difference between the motion vector of the current block and the motion vector predictor.

The predictor may generate a prediction signal based on various prediction methods and/or prediction techniques described later. For example, the predictor may apply intra prediction or inter prediction for the prediction of the current block, and it may also apply both intra prediction and inter prediction simultaneously. The prediction method that applies intra prediction and inter prediction simultaneously for the prediction of the current block may be referred to as combined inter and intra prediction (CIIP). Additionally, the predictor may perform intra block copy (IBC) for the prediction of the current block. Intra block copy may be used, for example, for screen content coding (SCC), etc. in applications such as game content image/video coding. IBC is a method of predicting the current block by using a pre-reconstructed reference block within the current picture, located at a predetermined distance from the current block. When IBC is applied, the position of the reference block within the current picture may be encoded as a vector (block vector) corresponding to the predetermined distance. IBC basically performs prediction within the current picture, but since it derives a reference block within the current picture, it may operate similarly to inter prediction. In other words, IBC may use at least one of the inter prediction methods described in the present disclosure.

The prediction signal generated by the predictor may be used to generate a reconstructed signal or to generate a residual signal. The subtractor 115 may generate a residual signal (residual block, residual sample array) by subtracting the prediction signal (predicted block, predicted sample array) output from the predictor from the input image signal (original block, original sample array). The generated residual signal may be transmitted to the transformer 120.

The transformer 120 may generate transform coefficients by applying a transform method to the residual signal. For example, the transform method may include at least one of Discrete Cosine Transform (DCT), Discrete Sine Transform (DST), Karhunen-Loeve Transform (KLT), Graph-Based Transform (GBT), or Conditionally Non-linear Transform (CNT). Here, GBT refers to a transform obtained from a graph when the relationship information between pixels is represented as a graph. CNT refers to a transform obtained based on a prediction signal generated by using all previously reconstructed pixels. The transform process may be applied to a pixel block of the same square size or to a non-square variable-sized block.

The quantizer 130 may quantize the transform coefficients and transmit them to the entropy encoder 190. The entropy encoder 190 may encode the quantized signal (information on the quantized transform coefficients) and output it as a bitstream. The information on the quantized transform coefficients may be referred to as residual information. The quantizer 130 may rearrange the block-shaped quantized transform coefficients into a one-dimensional vector based on a coefficient scan order and may generate the information on the quantized transform coefficients based on the one-dimensional vector of quantized transform coefficients.

The entropy encoder 190 may perform various encoding methods, such as exponential Golomb, context-adaptive variable length coding (CAVLC), or context-adaptive binary arithmetic coding (CABAC). The entropy encoder 190 may encode not only the quantized transform coefficients but also information necessary for video/image reconstruction (i.e., values of syntax elements) either together or separately with the quantized transform coefficients. The encoded information (i.e., encoded video/image information) may be transmitted or stored in the form of a bitstream in network abstraction layer (NAL) unit. The video/image information may further include information on various parameter sets, such as an adaptation parameter set (APS), a picture parameter set (PPS), a sequence parameter set (SPS), or a video parameter set (VPS). Additionally, the video/image information may further include general constraint information. The signaling information, transmitted information, and/or syntax elements described in the present disclosure may be included in the bitstream by being encoded through the above-described encoding process.

The bitstream may be transmitted through a network or stored in a digital storage medium. Here, the network may include a broadcast network and/or a communication network, etc., and the digital storage medium may include various storage media such as USB, SD, CD, DVD, Blu-ray, HDD, SSD, etc. A transmitter (not shown) for transmitting the signal output from the entropy encoder 190 and/or a storage unit (not shown) for storing the signal may be provided as an internal/external element of the image encoding apparatus 100, or the transmitter may be configured as a component of the entropy encoder 190.

The quantized transform coefficients output from the quantizer 130 may be used to generate a residual signal. For example, a residual signal (residual block or residual samples) may be reconstructed by applying dequantization and inverse transform to the quantized transform coefficients through the dequantizer 140 and the inverse transformer 150.

The adder 155 may generate a reconstructed signal (reconstructed picture, reconstructed block, or reconstructed sample array) by adding the reconstructed residual signal to the prediction signal output from the inter predictor 180 or the intra predictor 185. When there is no residual for the target block, such as when the skip mode is applied, the predicted block may be used as the reconstructed block. The adder 155 may be referred to as a reconstructor or a reconstructed block generator. The generated reconstructed signal may be used for intra prediction of the next target block within the current picture and, as described later, may also be used for inter prediction of the next picture after undergoing filtering.

The filter 160 may apply filtering to the reconstructed signal to enhance subjective/objective quality. For example, the filter 160 may apply various filtering methods to the reconstructed picture to generate a modified reconstructed picture, and the modified reconstructed picture may be stored in the memory 170, specifically in the DPB of the memory 170. The various filtering methods may include, for example, deblocking filtering, sample adaptive offset, adaptive loop filter, bilateral filter, etc. The filter 160 may generate various filtering-related information, as described later in the explanations of each filtering method, and may transmit it to the entropy encoder 190. The filtering-related information may be encoded by the entropy encoder 190 and output in the form of a bitstream.

The modified reconstructed picture transmitted to the memory 170 may be used as a reference picture in the inter predictor 180. When inter prediction is applied in this case, the image encoding apparatus 100 may avoid prediction mismatches between the image encoding apparatus 100 and the image decoding apparatus, and may improve encoding efficiency.

The DPB in the memory 170 may store the modified reconstructed picture for use as a reference picture in the inter predictor 180. The memory 170 may store the motion information of a block in the current picture where motion information has been derived (or encoded) and/or the motion information of blocks in already reconstructed pictures. The stored motion information may be transmitted to the inter predictor 180 for use as motion information of spatial neighboring block or temporal neighboring block. The memory 170 may store the reconstructed samples of reconstructed blocks in the current picture and transmit them to the intra predictor 185.

### Overview of the Image Decoding Apparatus

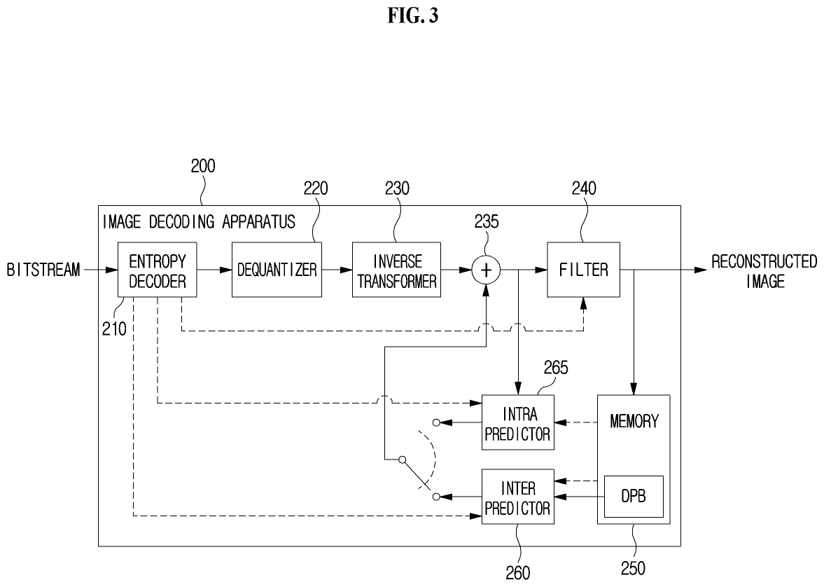

FIG. 3 shows a schematic diagram of an image decoding apparatus to which an embodiment according to the present disclosure may be applied.

As shown in FIG. 3, the image decoding apparatus 200 may include an entropy decoder 210, a dequantizer 220, an inverse transformer 230, an adder 235, a filter 240, a memory 250, an inter predictor 260, and an intra predictor 265. The inter predictor 260 and the intra predictor 265 may collectively be referred to as a “predictor”. The dequantizer 220 and the inverse transformer 230 may be included in a residual processor.

All or at least some of the multiple components constituting the image decoding apparatus 200 may be implemented as a single hardware component (i.e., a decoder or a processor), depending on the embodiment. Additionally, the memory 170 may include a DPB and may be implemented by a digital storage medium.

The image decoding apparatus 200, which receives a bitstream containing video/image information, may perform a process corresponding to the process performed by the image encoding apparatus 100 in FIG. 2 to reconstruct the image. For example, the image decoding apparatus 200 may perform decoding using the processing unit applied in the image encoding apparatus. Therefore, the processing unit for decoding may be, for example, a coding unit. The coding unit may be a coding tree unit or may be obtained by splitting a largest coding unit. Additionally, the reconstructed image signal decoded and output through the image decoding apparatus 200 may be played back through a playback device (not shown).

The image decoding apparatus 200 may receive a signal output from the image encoding apparatus in FIG. 2 in the form of a bitstream. The received signal may be decoded through the entropy decoder 210. For example, the entropy decoder 210 may parse the bitstream to extract the information necessary for image reconstruction (or picture reconstruction) (i.e., video/image information). The video/image information may further include information on various parameter sets, such as an adaptation parameter set (APS), a picture parameter set (PPS), a sequence parameter set (SPS), or a video parameter set (VPS). Additionally, the video/image information may further include general constraint information. The image decoding apparatus may additionally use information on the parameter set and/or the general constraint information to decode the image. The signaling information, received information, and/or syntax elements described in the present disclosure may be obtained from the bitstream by being decoded through the decoding process. For example, the entropy decoder 210 may decode the information in the bitstream based on coding methods such as exponential Golomb encoding, CAVLC, or CABAC, and may output a syntax element value necessary for image reconstruction and quantized values of a transform coefficient related to a residual. More specifically, the CABAC entropy decoding method may receive a bin corresponding to a syntax element in the bitstream, may determine a context model using the information of the decoding target syntax element, the decoding information of neighboring block and the decoding target block, or information of previously decoded symbol/bin, may predict the probability of bin occurrence according to the determined context model, and may perform arithmetic decoding of the bin to generate a symbol corresponding to each syntax element. In this case, the CABAC entropy decoding method may update the context model for the next symbol/bin context model using the decoded symbol/bin information after determining the context model. Among the decoded information from the entropy decoder 210, the prediction-related information may be provided to the predictor (inter predictor 260 and intra predictor 265), and the residual value which is entropy decoded by the entropy decoder 210, in other words, the quantized transform coefficients and related parameter information, may be input to the dequantizer 220. Additionally, among the decoded information from the entropy decoder 210, filtering-related information may be provided to the filter 240. Meanwhile, a receiver (not shown) that receives the signal output from the image encoding apparatus may be additionally configured as an internal/external element of the image decoding apparatus 200, or the receiver may be configured as a component of the entropy decoder 210.

Meanwhile, the image decoding apparatus according to the present disclosure may also be referred to as a video/image/picture decoding apparatus. The image decoding apparatus may include an information decoder (video/image/picture information decoder) and/or a sample decoder (video/image/picture sample decoder). The information decoder may include the entropy decoder 210, and the sample decoder may include at least one of the dequantizer 220, the inverse transformer 230, the adder 235, the filter 240, the memory 250, the inter predictor 260, or the intra predictor 265.

The dequantizer 220 may dequantize the quantized transform coefficients and output the transform coefficients. The dequantizer 220 may rearrange the quantized transform coefficients into a two-dimensional block. In this case, the rearrangement may be performed based on the coefficient scan order applied in the image encoding apparatus. The dequantizer 220 may perform dequantization on the quantized transform coefficients using quantization parameter (i.e., quantization step size information) and may obtain transform coefficients.

The inverse transformer 230 may perform an inverse transform on the transform coefficients to obtain a residual signal (residual block, or residual sample array).

The predictor may perform prediction for the current block and generate a predicted block that includes prediction samples for the current block. The predictor may determine whether intra prediction or inter prediction is applied to the current block based on the prediction-related information output from the entropy decoder 210 and may determine a specific intra/inter prediction mode (prediction method).

That the predictor may generate a prediction signal based on various prediction methods (techniques) which will be described later is the same as described in the explanation of the predictor in the image encoding apparatus 100.

The intra predictor 265 may predict the current block by referring to samples within the current picture. The explanation of the intra predictor 185 may also be applied in the same way to the intra predictor 265.

The inter predictor 260 may derive a predicted block for the current block based on a reference block (reference sample array) specified by a motion vector on a reference picture. In this case, to reduce the amount of motion information transmitted in the inter prediction mode, motion information may be predicted at the block, sub-block, or sample level based on the correlation of motion information between the neighboring block and the current block. The motion information may include a motion vector and a reference picture index. The motion information may further include information on the inter prediction direction (i.e., L0 prediction, L1 prediction, Bi prediction, etc.). In inter prediction, a neighboring block may include spatial neighboring block within the current picture and temporal neighboring block in the reference picture. For example, the inter predictor 260 may construct a motion information candidate list based on neighboring blocks and derive the motion vector and/or reference picture index of the current block based on the received candidate selection information. Inter prediction may be performed based on various prediction modes (methods), and the prediction-related information may include information indicating the inter prediction mode (method) applied to the current block.

The adder 235 may generate a reconstructed signal (reconstructed picture, reconstructed block, reconstructed sample array) by adding the obtained residual signal to the prediction signal (predicted block, predicted sample array) output from the predictor (including the inter predictor 260 and/or the intra predictor 265). When there is no residual for the target block, such as when the skip mode is applied, the predicted block may be used as the reconstructed block. The explanation of the adder 155 may also be applied in the same way to the adder 235. The adder 235 may be referred to as a reconstructor or a reconstructed block generator. The generated reconstructed signal may be used for intra prediction of the next target block within the current picture and as described later, may also be used for inter prediction of the next picture after undergoing filtering.

The filter 240 may apply filtering to the reconstructed signal to enhance subjective/objective quality. For example, the filter 240 may apply various filtering methods to the reconstructed picture to generate a modified reconstructed picture, and the modified reconstructed picture may be stored in the memory 250, specifically in the DPB of the memory 250. The various filtering methods may include, for example, deblocking filtering, sample adaptive offset, adaptive loop filter, bilateral filter, etc.

The (modified) reconstructed picture stored in the DPB of the memory 250 may be used as a reference picture in the inter predictor 260. The memory 250 may store the motion information of a block in the current picture where motion information has been derived (or decoded) and/or the motion information of blocks in already reconstructed picture. The stored motion information may be transmitted to the inter predictor 260 to be used as motion information of a spatial neighboring block or a temporal neighboring block. The memory 250 may store the reconstructed samples of reconstructed blocks in the current picture and transmit them to the intra predictor 265.

In this specification, the embodiments described for the filter 160, the inter predictor 180, and the intra predictor 185 of the image encoding apparatus 100 may be applied in the same or corresponding manner to the filter 240, the inter predictor 260, and the intra predictor 265 of the image decoding apparatus 200.

### Inter Prediction

The predictor of an image encoding apparatus 100 and an image decoding apparatus 200 may perform inter prediction in a block unit to derive a prediction sample. Inter prediction may be prediction derived in a manner dependent on data elements (e.g., sample values, or motion information, etc.) of picture(s) other than a current picture. When inter prediction is applied to a current block, a predicted block (a prediction sample array) for a current block may be derived based on a reference block (a reference sample array) specified by a motion vector on a reference picture indicated by a reference picture index. In this case, in order to reduce the amount of motion information transmitted in an inter prediction mode, the motion information of a current block may be predicted in a block, sub-block or sample unit based on the correlation of motion information between a neighboring block and a current block. The motion information may include a motion vector and a reference picture index. The motion information may further include information on an inter prediction type (L0 prediction, L1 prediction, Bi prediction, etc.). When inter prediction is applied, a neighboring block may include a spatial neighboring block existing in a current picture and a temporal neighboring block existing in a reference picture. A reference picture including the reference block and a reference picture including the temporal neighboring block may be the same or different. The temporal neighboring block may be called a collocated reference block, a collocated CU (colCU), etc., and a reference picture including the temporal neighboring block may be called a collocated picture (colPic). For example, a motion information candidate list may be constructed based on neighboring blocks of a current block, and flag or index information indicating which candidate is selected (used) to derive the motion vector and/or reference picture index of the current block may be signaled. Inter prediction may be performed based on various prediction modes, and for example, in case of a skip mode and a merge mode, the motion information of a current block may be the same as the motion information of a selected neighboring block. For a skip mode, unlike a merge mode, a residual signal may not be transmitted. For a motion vector prediction (MVP) mode, the motion vector of a selected neighboring block may be used as a motion vector predictor, and a motion vector difference may be signaled. In this case, the motion vector of the current block may be derived by using the sum of the motion vector predictor and the motion vector difference.

The motion information may include L0 motion information and/or L1 motion information according to an inter prediction type (L0 prediction, L1 prediction, Bi prediction, etc.). A motion vector in a L0 direction may be called a L0 motion vector or MVL0, and a motion vector in a L1 direction may be called a L1 motion vector or MVL1. Prediction based on a L0 motion vector may be called L0 prediction, prediction based on a L1 motion vector may be called L1 prediction and prediction based on both the L0 motion vector and the L1 motion vector may be called bi-prediction. Here, a L0 motion vector may represent a motion vector associated with reference picture list L0 (L0), and a L1 motion vector may represent a motion vector associated with reference picture list L1 (L1). Reference picture list L0 may include pictures before the current picture in output order as reference pictures, and reference picture list L1 may include pictures after the current picture in output order. The previous pictures may be called a forward (reference) picture, and the subsequent pictures may be called a backward (reference) picture. The reference picture list L0 may further include pictures after the current picture in output order as reference pictures. In this case, the previous pictures may be indexed first and the subsequent pictures may be indexed next within the reference picture list L0. The reference picture list L1 may further include pictures before the current picture in output order as reference pictures. In this case, the subsequent pictures may be indexed first and the previous pictures may be indexed next within the reference picture list 1. Here, output order may correspond to picture order count (POC) order.

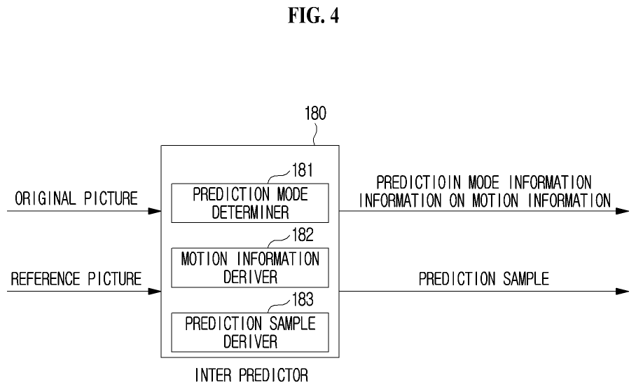

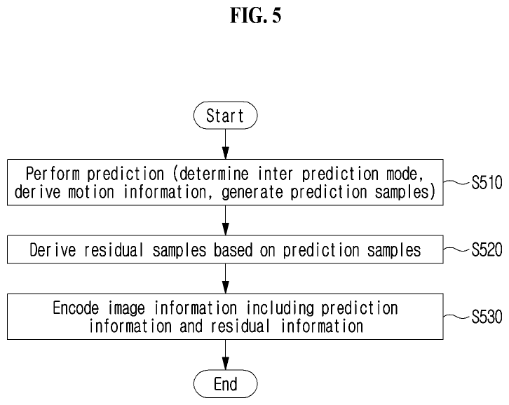

FIG. 4 is a diagram schematically representing an inter predictor 180 of an image encoding apparatus 100, and FIG. 5 is a flowchart representing a method for encoding an image based on inter prediction.

An image encoding apparatus 100 may perform inter prediction on a current block S510. An image encoding apparatus 100 may derive the inter prediction mode and motion information of a current block and generate prediction samples of the current block. Here, procedures of determining an inter prediction mode, deriving motion information and generating prediction samples may be performed simultaneously or any one procedure may be performed before other procedures. For example, the inter predictor 180 of an image encoding apparatus 100 may include a prediction mode determiner 181, a motion information deriver 182 and a prediction sample deriver 183, and may determine a prediction mode for the current block in a prediction mode determiner 181, derive motion information of the current block in a motion information deriver 182 and derive prediction samples of the current block in a prediction sample deriver 183. For example, the inter predictor 180 of an image encoding apparatus 100 may search for a block similar to the current block within a certain region (a search range) of reference pictures through motion estimation and derive a reference block whose difference from the current block is minimal or less than or equal to a certain standard. Based thereon, a reference picture index indicating a reference picture where the reference block is positioned may be derived, and a motion vector may be derived based on a positional difference between the reference block and the current block. An image encoding apparatus 100 may determine a mode applied to the current block among various prediction modes. An image encoding apparatus 100 may compare a RD cost for the various prediction modes and determine an optimal prediction mode for the current block.

For example, when a skip mode or a merge mode is applied to the current block, an image encoding apparatus 100 may construct a merge candidate list described below and derive a reference block whose difference from the current block is minimal or less than or equal to a certain standard among the reference blocks indicated by merge candidates included in the merge candidate list. In this case, a merge candidate associated with the derived reference block may be selected, and merge index information indicating the selected merge candidate may be generated and signaled to a decoding device. The motion information of the current block may be derived by using the motion information of the selected merge candidate.

As another example, when an (A)MVP mode is applied to the current block, an image encoding apparatus 100 may construct an (A)MVP candidate list described below and use the motion vector of a motion vector predictor (mvp) candidate selected among the mvp candidates included in the (A)MVP candidate list as the mvp of the current block. In this case, for example, a motion vector indicating a reference block derived by motion estimation described above may be used as the motion vector of the current block, and a mvp candidate having a motion vector with the smallest difference from the motion vector of the current block among the mvp candidates may become the selected mvp candidate. A motion vector difference (MVD) which is a difference obtained by subtracting the mvp from the motion vector of the current block may be derived. In this case, information about the MVD may be signaled to an image decoding apparatus 200. In addition, when an (A)MVP mode is applied, the value of the reference picture index may be constructed as reference picture index information and signaled separately to the image decoding apparatus 200.

An image encoding apparatus 100 may derive residual samples based on the prediction samples S520. An image encoding apparatus 100 may derive the residual samples by comparing the original samples of the current block with the prediction samples.

An image encoding apparatus 100 may encode image information including prediction information and residual information S530. An image encoding apparatus 100 may output encoded image information in the form of a bitstream. The prediction information is information related to the prediction procedure, and may include information about prediction mode information (e.g., a skip flag, a merge flag or a mode index, etc.) and motion information. The information about motion information may include candidate selection information (e.g., a merge index, a mvp flag or a mvp index) which is information for deriving a motion vector. In addition, the information about motion information may include information about the above-described MVD and/or reference picture index information. In addition, the information about motion information may include information representing whether L0 prediction, L1 prediction or bi-prediction is applied. The residual information is information about the residual samples. The residual information may include information about quantized transform coefficients for the residual samples.

An output bitstream may be stored in a (digital) storage medium and transmitted to a decoding device or may be transmitted to an image decoding apparatus 200 through a network.

Meanwhile, as described above, an image encoding apparatus 100 may generate a reconstructed picture (including reconstructed samples and reconstructed blocks) based on the reference samples and the residual samples. This is to derive the same prediction result as that performed by an image decoding apparatus 200 from an image encoding apparatus 100, which may improve coding efficiency. Accordingly, an image encoding apparatus 100 may store a reconstructed picture (or reconstructed samples, reconstructed blocks) in a memory and utilize it as a reference picture for inter prediction. As described above, an in-loop filtering procedure, etc. may be further applied to the reconstructed picture.

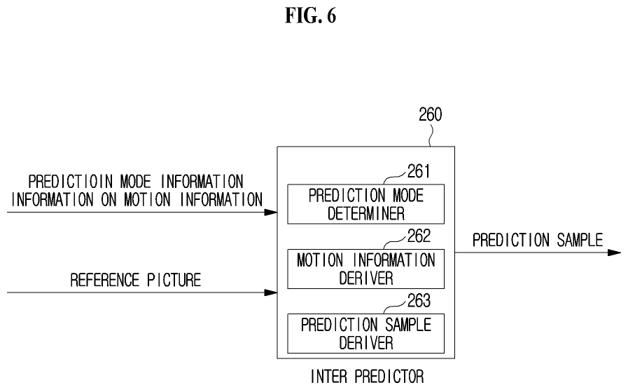

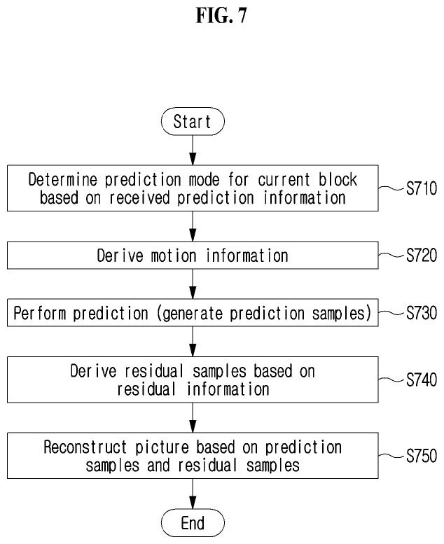

FIG. 6 is diagram schematically representing an inter predictor 260 of an image decoding apparatus 200, and FIG. 7 is a flowchart representing a method for decoding an image based on inter prediction.

An image decoding apparatus 200 may perform an operation corresponding to an operation performed in the image encoding apparatus 100. An image decoding apparatus 200 may perform prediction on a current block based on received prediction information and derive prediction samples.

Specifically, an image decoding apparatus 200 may determine a prediction mode for the current block based on received prediction information S710. An image decoding apparatus 200 may determine which inter prediction mode is applied to the current block based on prediction mode information within the prediction information.

For example, whether the merge mode or the (A)MVP mode is applied to the current block may be determined based on the merge flag. Alternatively, one of various inter prediction mode candidates may be selected based on the mode index. The inter prediction mode candidates may include a skip mode, a merge mode and/or an (A)MVP mode or may include various inter prediction modes described below.

An image decoding apparatus 200 may derive motion information of the current block based on the determined inter prediction mode S720. For example, when a skip mode or a merge mode is applied to the current block, an image decoding apparatus 200 may construct a merge candidate list described below and select one of the merge candidates included in the merge candidate list. The selection may be performed based on the above-described selection information (merge index). The motion information of the current block may be derived by using the motion information of the selected merge candidate. The motion information of the selected merge candidate may be used as the motion information of the current block.

As another example, when an (A)MVP mode is applied to the current block, an image decoding apparatus 200 may construct an (A)MVP candidate list described below and use the motion vector of a mvp candidate selected among the motion vector predictor (mvp) candidates included in the (A)MVP candidate list as the mvp of the current block. The selection may be performed based on the above-described selection information (a mvp flag or a mvp index). In this case, the MVD of the current block may be derived based on information about the MVD, and the motion vector of the current block may be derived based on the mvp of the current block and the MVD. In addition, the reference picture index of the current block may be derived based on the reference picture index information. A picture indicated by the reference picture index in a reference picture list for the current block may be derived as a reference picture referred to for inter prediction of the current block.

Meanwhile, as described below, motion information of the current block may be derived without constructing a candidate list, and in this case, motion information of the current block may be derived according to a procedure initiated in a prediction mode described below. In this case, candidate list construction as described above may be omitted.

An image decoding apparatus 200 may generate prediction samples for the current block based on the motion information of the current block S730. In this case, the reference picture may be derived based on the reference picture index of the current block, and prediction samples of the current block may be derived by using samples of a reference block indicated by the motion vector of the current block on the reference picture. In this case, as described below, a prediction sample filtering procedure for all or part of prediction samples of the current block may be further performed in some cases.

For example, the inter predictor 260 of an image decoding apparatus 200 may include a prediction mode determiner 261, a motion information deriver 262 and a prediction sample deriver 263, and may determine a prediction mode for the current block based on prediction mode information received in a prediction mode determiner 181, derive motion information (a motion vector and/or a reference picture index, etc.) of the current block based on information about motion information received in a motion information deriver 182 and derive prediction samples of the current block in a prediction sample deriver 183.

An image decoding apparatus 200 may generate residual samples for the current block based on received residual information S740. An image decoding apparatus 200 may generate reconstructed samples for the current block based on the prediction samples and the residual samples and generate a reconstructed picture based on this S750. Hereinafter, as described above, an in-loop filtering procedure, etc. may be further applied to the reconstructed picture.

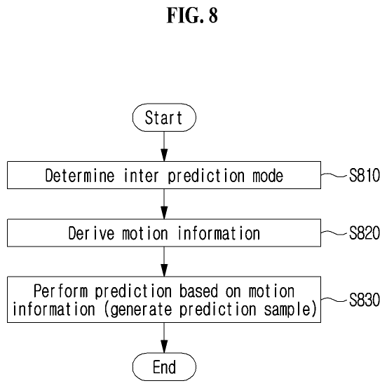

Referring to FIG. 8, as described above, an inter prediction procedure may include an inter prediction mode determination step S810, a motion information derivation step S820 according to a determined prediction mode and a prediction performance (prediction sample generation) step S830 based on derived motion information. The inter prediction procedure may be performed in an image encoding apparatus 100 and an image decoding apparatus 200 as described above.

### Determine an Inter Prediction Mode

A variety of inter prediction modes may be used for prediction of a current block in a picture. For example, various modes such as a merge mode, a skip mode, a motion vector prediction (MVP) mode, an affine mode, a sub-block merge mode, a merge with MVD (MMVD) mode, etc. may be used. A decoder side motion vector refinement (DMVR) mode, an adaptive motion vector resolution (AMVR) mode, a bi-prediction with CU-level weight (BCW), a bi-directional optical flow (BDOF), etc. may be used as an additional or alternative mode. An affine mode may also be called an affine motion prediction mode. A MVP mode may also be called an advanced motion vector prediction (AMVP) mode. In this document, some modes and/or a motion information candidate derived by some modes may be included as one of the motion information-related candidates of other modes. For example, a HMVP candidate may be added as the merge candidate of the merge/skip mode or may be added as the mvp candidate of the MVP mode.

Prediction mode information indicating the inter prediction mode of a current block may be signaled from an image encoding apparatus 100 to an image decoding apparatus 200. The prediction mode information may be included in a bitstream and received by an image decoding apparatus 200. The prediction mode information may include index information indicating one of multiple candidate modes. Alternatively, an inter prediction mode may be indicated through hierarchical signaling of flag information. In this case, the prediction mode information may include at least one flag. For example, whether to apply a skip mode may be indicated by signaling a skip flag, and when a skip mode is not applied, whether to apply a merge mode may be indicated by signaling a merge flag, and when a merge mode is not applied, a MVP mode may be indicated to be applied or a flag for additional distinction may be further signaled. An affine mode may be signaled as an independent mode or may be signaled as a dependent mode such as a merge mode or a MVP mode, etc. For example, an affine mode may include an affine merge mode and an affine MVP mode.

### Motion Information Derivation

Inter prediction may be performed by using the motion information of a current block. An image encoding apparatus 100 may derive optimal motion information for a current block through a motion estimation procedure. For example, an image encoding apparatus 100 may use an original block within an original picture for a current block to search for a similar reference block with high correlation in a fractional pixel unit within a predetermined search range within a reference picture and derive motion information through this. The similarity of blocks may be derived based on a difference in phase-based sample values. For example, the similarity of blocks may be calculated based on a SAD between a current block (or the template of a current block) and a reference block (or the template of a reference block). In this case, motion information may be derived based on a reference block with the smallest SAD within a search range. The derived motion information may be signaled to an image decoding apparatus 200 according to various methods based on an inter prediction mode.

### Prediction Sample Generation

A predicted block for a current block may be derived based on motion information derived according to a prediction mode. The predicted block may include prediction samples (prediction sample arrays) of the current block. When the motion vector of a current block indicates a fractional sample unit, an interpolation procedure may be performed, and through this, prediction samples of the current block may be derived based on reference samples in a fractional sample unit within a reference picture. When affine inter prediction is applied to a current block, prediction samples may be generated based on an MV in a sample/sub-block unit. When bi-prediction is applied, prediction samples derived through the weighted sum or weighted average (according to a phase) of prediction samples derived based on L0 prediction (i.e., prediction using MVL0 and a reference picture within reference picture list L0) and prediction samples derived based on L1 prediction (i.e., prediction using MVL1 and a reference picture within reference picture list L1) may be used as the prediction samples of a current block. When bi-prediction is applied, if a reference picture used for L0 prediction and a reference picture used for L1 prediction are positioned in a different temporal direction based on a current picture (i.e., when it corresponds to bi-prediction and bidirectional prediction), it may be called true bi-prediction.

As described above, reconstructed samples and reconstructed pictures may be generated based on derived prediction samples, and a procedure such as in-loop filtering, etc. may be performed thereafter.

### Template Matching (TM)

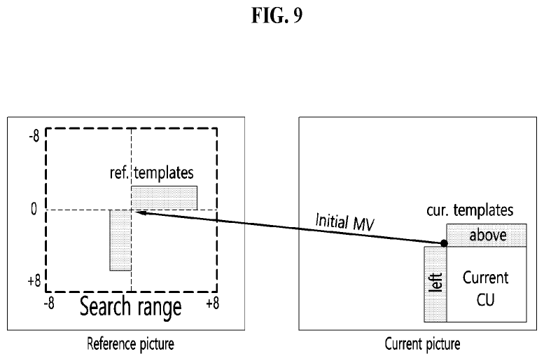

FIG. 9 is a diagram for describing a template matching-based encoding/decoding method according to the present disclosure.

Template Matching (TM) is a method for deriving a motion vector performed on a decoder side, which is a method in which the motion information of a current block may be refined by finding a template (hereinafter referred to as a “reference template”) in a reference picture that is most similar to a template (hereinafter referred to as a “current template”) adjacent to a current block (e.g., a current coding unit, a current CU). A current template may be the top neighbor block and/or left neighbor block of a current block or a part of these neighbor blocks. In addition, a reference template may be determined to have the same size as a current template.

As shown in FIG. 9, when the initial motion vector of a current block is derived, a search for a better motion vector may be performed in the neighboring region of an initial motion vector. For example, the range of a neighboring region where the search is performed may be within a [−8, +8]-pel search range based on an initial motion vector. In addition, the size of a search step for performing a search may be determined based on the AMVR mode of a current block. In addition, template matching may also be performed continuously with a bilateral matching process in a merge mode.

When the prediction mode of a current block is an AMVP mode, a motion vector predictor candidate (an MVP candidate) may be determined based on a template matching error. For example, a motion vector predictor candidate (an MVP candidate) that minimizes an error between a current template and a reference template may be selected. Afterwards, template matching for refining a motion vector may be performed on the selected motion vector predictor candidate. In this case, template matching for refining a motion vector may not be performed on a motion vector predictor candidate that is not selected.

More specifically, refinement for the selected motion vector predictor candidate may start from full-pel (integer-pel) accuracy within a [−8, +8]-pel search range by using an iterative diamond search. Alternatively, for a 4-pel AMVR mode, it may start from 4-pel accuracy. Afterwards, a search for half-pel and/or quarter-pel accuracy may be followed according to an AMVR mode. According to the search process, a motion vector predictor candidate may maintain the same motion vector accuracy as indicated by an AMVR mode even after a template matching process. In the iterative search process, when a difference between a previous minimum cost and a current minimum cost is less than an arbitrary threshold value, the search process is terminated. The threshold value may be the same as the area of a block, i.e., the number of samples in a block. Table 1 shows an example of a search pattern according to an AMVR mode and a merge mode accompanied by AMVR.

TABLE 1

| | AMVR mode | | | | | |
|---|---|---|---|---|---|---|
| | | | | Quarter- | Merge mode | |
| Search pattern | 4-pel | Full-pel | Half-pel | pel | AltIF = 0 | AltIF = 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

When the prediction mode of a current block is a merge mode, a similar search method may be applied to a merge candidate indicated by a merge index. As shown in the Table 1, template matching may be performed up to 1/8-pel accuracy or may skip half-pel accuracy or less, which may be determined depending on whether an alternative interpolation filter is used according to merge motion information. In this case, the alternative interpolation filter may be a filter used when AMVR is a half-pel mode. In addition, when template matching is available, the template matching may operate as an independent process according to whether bilateral matching (BM) is available or may operate as an additional motion vector refinement process between block-based bilateral matching and sub-block-based bilateral matching. Whether the template matching is available and/or whether bilateral matching is available may be determined according to availability condition check. In the above, the accuracy of a motion vector may refer to the accuracy of a motion vector difference (MVD).

Adaptive Reordering of Merge Candidates with Template Matching (ARMC-TM)

The merge candidates may be adaptively rearranged through template matching. The rearrangement method may be applied to a regular merge mode, a template matching (TM) merge mode and an affine merge mode (excluding an SbTMVP candidate). For a TM merge mode, the rearrangement of merge candidates may be performed before the above-described motion vector refinement process.

After a merge candidate list is constructed, merge candidates may be partitioned into one or more subgroups. The size of a subgroup for a regular merge mode and a TM merge mode may be 5. In addition, the size of a subgroup for an affine merge mode may be 3. The merge candidates within each subgroup may be rearranged in ascending order according to template matching-based cost values. For simplicity, merge candidates within the last subgroup, not the first subgroup, may not be rearranged.

The template matching cost of a merge candidate may be measured by the sum of absolute difference (SAD) between the samples of the template of a current block and reference samples corresponding thereto. In this case, a template may include a set of reconstructed samples neighboring a current block. The positions of reference samples of the template may be specified by motion information of a merge candidate.

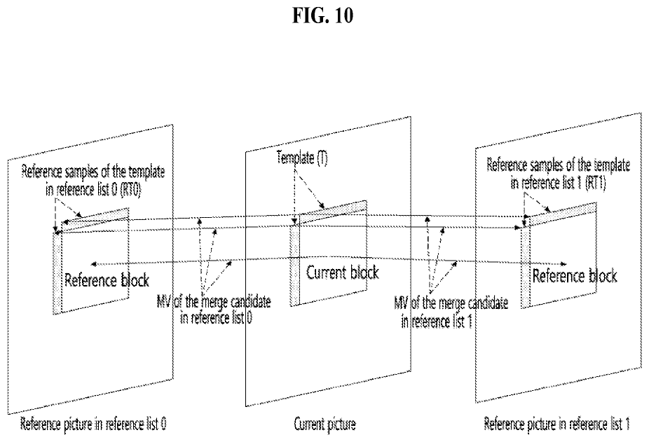

FIG. 10 is a diagram illustrating the template of a current block and reference samples of a template within reference pictures. When a merge candidate uses bidirectional prediction, the reference samples of the template of the merge candidate may be generated as illustrated in FIG. 10. Specifically, a reference block within a list 0 reference picture may be specified based on the list 0 (L0) motion vector of the merge candidate of a current block, and then a reference template within a list 0 reference picture (reference template 0, RT0) may be specified. Similarly, a reference block within a list 1 reference picture may be specified based on the list 1 (L1) motion vector of the merge candidate of a current block, and then a reference template within a list 1 reference picture (reference template 1, RT1) may be specified.

For a sub-block-based merge candidate where the size of a sub-block is Wsub×Hsub, an above template may include one or more Wsub×1-sized sub-templates and a left template may include one or more 1×Hsub-sized sub-templates.

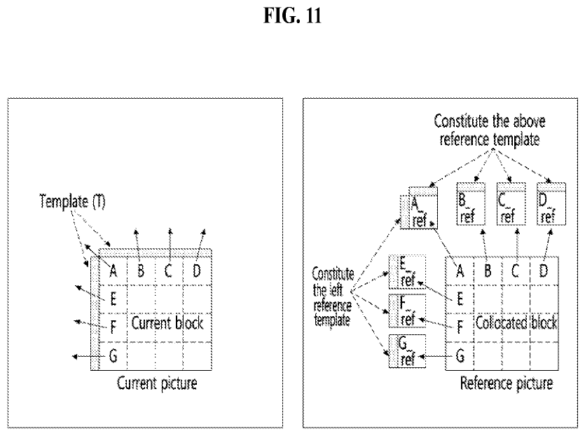

FIG. 11 is a diagram for describing a method for specifying a template by using motion information of a sub-block.

In an example illustrated in FIG. 11, the reference samples of each sub-template may be derived by using the motion information of sub-blocks included in the first column and the first row of a current block. More specifically, reference sub-blocks corresponding to a reference picture (A_ref, B_ref, C_ref, D_ref, E_ref, F_ref, G_ref) may be specified by using the motion vectors of sub-blocks (A, B, C, D, E, F, G) included in the first column and the first row of a current block within a current picture. For example, the position of a corresponding reference sub-block may be specified from a collocated block within a reference picture based on the motion vector of each sub-block. Afterwards, a reference template may be constructed from a reconstructed area adjacent to each reference sub-block. As illustrated in FIG. 11, when the size of a sub-block is Wsub×Hsub, an above reference template may include one or more Wsub×1-sized sub-reference templates and a left reference template may include one or more 1×Hsub-sized sub-reference templates.

In the present disclosure, template matching may be the process of searching for a reference template with the highest similarity to a current template. According to the present disclosure, a template matching cost may be calculated to measure the similarity, and a cost function such as SAD may be used for this purpose. When a template matching cost is high, it may mean that a template matching error is large and accordingly, a similarity between templates is low. Conversely, when a template matching cost is low, it may mean that a template matching error is small and accordingly, a similarity between templates is high.

In the present disclosure, a cost function for calculating a template matching cost may be a function that uses a difference between a sample value within a current template and a corresponding sample value within a reference template. Accordingly, the cost function may be referred to as “difference (error)-based function” or “difference (error)-based equation” between corresponding samples within two templates. In addition, a template matching cost calculated by the cost function may be referred to as “difference (error)-based function value” or “difference (error)-based value” between corresponding samples within two templates.

Hereinafter, various embodiments according to the present disclosure will be described by referring to drawings.

### Embodiment

Various embodiments of the present disclosure relate to technologies related to the above-described image encoding/decoding operation, and particularly may be associated with template matching described above. According to an embodiment of the present disclosure, it relates to a method for constructing a generalized (i.e., complex) merge candidate list based on template matching in the process of constructing a prediction candidate list during inter prediction and deriving motion information and generating a prediction block by referring to the candidate of a generalized (i.e., complex) merge candidate list.

As an example, according to the present disclosure, prediction candidates with various characteristics such as conventional regular merge, CIIP merge, GPM merge, MMVD merge, SbTMVP merge, affine merge, etc. may be constructed into one prediction candidate list. Here, a different prediction candidate among the prediction candidates with various characteristics may be used to include prediction blocks with different characteristics not only when a method for deriving a motion vector is different such as conventional regular merge, affine merge, etc., but also when a final prediction block is different due to a difference in BCW, an interpolation filter, etc. even when it is a prediction candidate with the same motion vector.

In addition, according to an embodiment of the present disclosure, a method for calculating the template matching error of various prediction candidates is proposed. In addition, according to the present disclosure, when various prediction candidates are constructed into one list, a priority among the prediction candidates may be determined based on a template matching error. As an example, a method for constructing prediction candidates with various characteristics to be included in one prediction candidate list and ordering them from a prediction candidate with high similarity to a prediction candidate with low similarity according to template similarity and a method for generating a prediction block by using motion information derived from a proposed prediction candidate list are proposed.

According to an embodiment of the present disclosure, a prediction candidate list constructed with motion information of different characteristics may be constructed, so compression efficiency may be refined while minimizing the amount of bits required for signaled information.

According to embodiments of the present disclosure, one list including a prediction candidate with various characteristics may be constructed, and candidates below may be included in a prediction candidate list.
1. Regular merge using the motion information of a neighboring block
2. Merge with MVD (motion vector difference) (MMVD) which derives motion information by applying an additional compensation value to the motion information of a neighboring block
3. Combined inter-intra prediction (CIIP) which blends a prediction block generated by the motion information of a neighboring block and a prediction block generated by intra prediction by referring to the neighboring pixel of a current block
4. Multi-hypothesis prediction which blends three or more prediction blocks derived by motion information
5. Affine which derives motion information in the unit of a sub-block through an affine model by referring to neighboring motion information
6. Temporal motion vector prediction (TMVP) and Subblock-based temporal motion vector prediction (SbTMVP) which refer to the motion information of a pre-decoded reference picture
7. Geometric partitioning which blends a prediction block in a geometric shape

As an example, one prediction candidate list including all of the prediction candidates listed above may be proposed. In addition, as an example, prediction candidates in a prediction candidate list may be ordered from a prediction candidate with high similarity to a prediction candidate with low similarity based on the similarity of templates.

For example, as shown in Table 2 below, it is assumed there is a prediction candidate list including a prediction candidate.

TABLE 2

| Index | Chacteristic | Detail |
|---|---|---|
| 0 | Above neighbor candidate | Regular merge |
| | | (as regular merge) |
| 1 | Left neighbor candidate | Regular merge |
| | | (as regular merge) |
| 2 | Left-Above neighbor candidate | Regular merge |
| | | (as regular merge) |
| 3 | Above neighbor candidate + MMVD offset 1 | MMVD merge |
| | | (as MMVD merge) |
| 4 | Above neighbor candidate + MMVD offset 2 | MMVD merge |
| | | (as MMVD merge) |
| 5 | Constructed affine candidate 1 | Affine merge |
| | | (as affine merge) |
| 6 | Inherited affine candidate 1 | Affine merge |
| | | (as affine merge) |
| 7 | Inherited affine candidate 2 | Affine merge |
| | | (as affine merge) |
| 8 | Multi-hypothesis candidate 1 | MHP |
| | | (as MHP) |
| 9 | Multi-hypothesis candidate 2 | MHP |
| | | (as MHP) |
| 10 | TMVP | TMVP |
| | | (as TMVP) |
| 11 | SbTMVP | sbTMVP |
| | | (as sbTMVP) |
| 12 | GEO candidate 1 | GPM |
| | | (as GPM) |
| 13 | GEO candidate 2 | GPM |
| | | (as GPM) |
| 14 | CIIP candidate 1 | CIIP |
| | | (as CIIP) |
| 15 | CIIP candidate 2 | CIIP |
| | | (as CIIP) |

As an example, when the template similarity of a prediction candidate included in a prediction candidate list expressed in Table 2 above is represented as a cost (or an error), it may be the same as shown in Table 3 below.

TABLE 3

| Index | Chacteristic | cost |
|---|---|---|
| 0 | Above neighbor candidate | 10 |
| 1 | Left neighbor candidate | 110 |
| 2 | Left-Above neighbor candidate | 100 |
| 3 | Above neighbor candidate + MMVD offset 1 | 30 |
| 4 | Above neighbor candidate + MMVD offset 2 | 20 |
| 5 | Constructed affine candidate 1 | 90 |
| 6 | Inherited affine candidate 1 | 40 |
| 7 | Inherited affine candidate 2 | 120 |
| 8 | Multi-hypothesis candidate 1 | 80 |
| 9 | Multi-hypothesis candidate 2 | 50 |
| 10 | TMVP | 130 |
| 11 | SbTMVP | 60 |
| 12 | GEO (geometric partitioning) candidate 1 | 70 |
| | (GEO candidate 1) | |
| 13 | GEO candidate 2 | 160 |
| 14 | CIIP candidate 1 | 150 |
| 15 | CIIP candidate 2 | 140 |

When it is defined that as an error in Table 3 above is smaller, it has higher similarity, a candidate with high similarity may be ordered to have a higher priority than a candidate with low similarity as shown in Table 4 below.

TABLE 4

| Index | Characteristic | cost |
|---|---|---|
| 0 | Above neighbor candidate | 10 |
| 1 | Above neighbor candidate + MMVD offset 2 | 20 |
| 2 | Above neighbor candidate + MMVD offset 1 | 30 |
| 3 | Inherited affine candidate 1 | 40 |
| 4 | Multi-hypothesis candidate 2 | 50 |
| 5 | SbTMVP | 60 |
| 6 | GEO candidate 1 | 70 |
| 7 | Multi-hypothesis candidate 1 | 80 |
| 8 | Constructed affine candidate 1 | 90 |
| 9 | Left-Above neighbor candidate | 100 |
| 10 | Left neighbor candidate | 110 |
| 11 | Inherited affine candidate 2 | 120 |
| 12 | TMVP | 130 |
| 13 | CIIP candidate 2 | 140 |
| 14 | CIIP candidate 1 | 150 |
| 15 | GEO candidate 2 | 160 |

As shown in Table 4 above, an ordered prediction candidate list may be obtained from encoder and decoder sides, and on the encoder side, information on a candidate actually used for prediction, i.e., an actually selected prediction candidate (e.g., a prediction candidate index) may be signaled in a bitstream. For example, when a prediction candidate corresponding to prediction candidate index 2 in Table 4 above, i.e., a prediction candidate based on an above neighbor candidate+MMVD offset 1 is selected, a prediction candidate index may need to be signaled in a bitstream. In this case, in order to define a corresponding prediction candidate in a conventional manner, information on whether a regular merge is used (e.g., regular_merge_flag), information on whether an MMVD merge is used (e.g., mmvd_merge_flag), an MMVD-based candidate index (e.g., mmvd_base_candidate_idx), an MMVD direction index (e.g., mmvd_direction_idx) and an MMVD offset index (e.g., mmvd_offset_idx) must be signaled. However, according to an embodiment of the present disclosure, only information on whether generalized (i.e., complex) merge is applied (e.g., proposed_generalized_merge_flag) and a prediction candidate index (e.g., a merge index, merge_idx) may be signaled, so compression efficiency may be refined by using reduced bits compared to before.

Meanwhile, according to an embodiment of the present disclosure, a template matching error for each prediction candidate may be calculated to represent the template similarity of each prediction candidate. In addition, when a prediction candidate with various characteristics is included in one prediction candidate list, it may be ordered in descending order of priority according to the value of a template matching error proposed as an embodiment of the present disclosure.

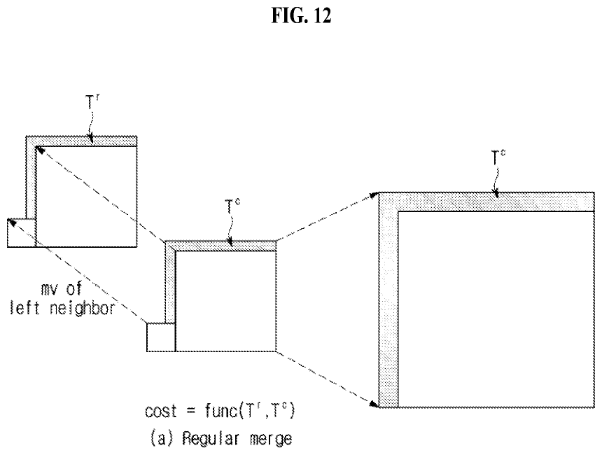

FIG. 12 is a diagram for describing an example of a method for deriving a template matching error according to an embodiment of the present disclosure. In order to determine a priority among the prediction candidates by comparing template matching errors among the prediction candidates derived in various ways which are included in a generalized (i.e., complex) merge list according to an embodiment of the present disclosure, an example of calculating a template matching error is described below by referring to FIG. 12.

An embodiment shown in FIG. 12 relates to a method for calculating the template matching error of a regular merge prediction candidate. As a merge prediction motion candidate, the motion information of a decoded prediction block at a predefined position (e.g., left or above, etc.) may be used. According to an embodiment shown in FIG. 12, the motion information of a decoded prediction block located at a predefined position (e.g., left) may be used. As an example, a template matching error may be expressed as a cost, and a corresponding error value (cost) may be derived based on a difference (error) value between the pixel value of the template area of a reference picture referenced by motion information (T^{r}) and a decoded pixel located around a current block (T^{c}). In addition, as an example, func( ) illustrated in FIG. 12 may be defined as various metrics such as SAD, MR-SAD (Mean-Reduced SAD), etc.

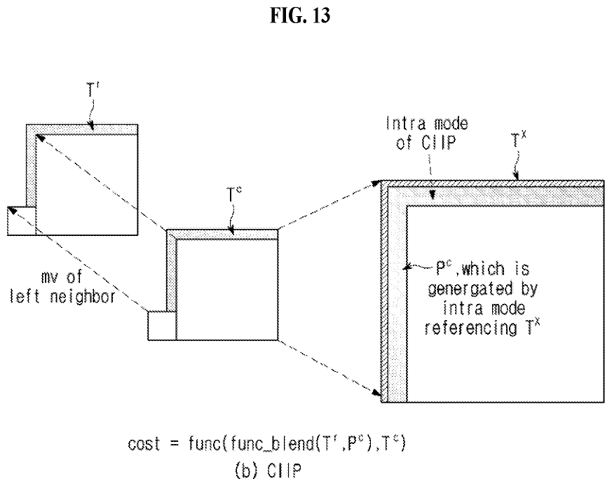

Meanwhile, FIG. 13 is a diagram for describing an example of a method for calculating a template matching error according to an embodiment of the present disclosure. More specifically, it is a diagram regarding a method for calculating the template matching error of a CIIP prediction candidate. In an example of calculating a template matching error according to an embodiment of the present disclosure, the motion information of a decoded prediction block at a predefined position (e.g., left or above, etc.) may be used as a merge prediction motion candidate. According to an embodiment shown in FIG. 13, as an example for the case of an intra prediction mode with the motion information of a decoded prediction block located at a predefined position (e.g., left), a matching error may be expressed as a cost, and a corresponding cost may be derived as a difference (error) value between the pixel value of the template area of a reference picture referenced by motion information (T^{r}) and an intra prediction block (P^{c}) derived by referring to the neighboring decoded pixel of a current block (T^{X}). In FIG. 13, func( ) may be defined as various metrics such as SAD, MR-SAD (Mean-Reduced SAD), etc. In addition, the Func_blend( ) function may be derived as a function using the weighted average of an intra prediction block (P^{c}) and the pixel value of the template area of a reference picture (T^{r}) when deriving a template matching error.

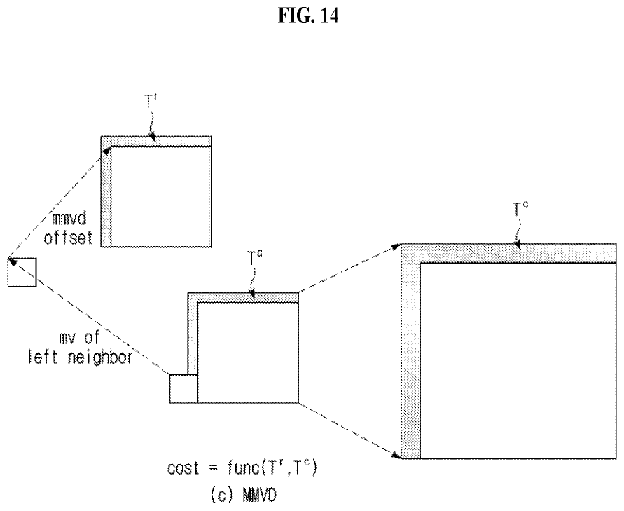

FIG. 14 is a diagram for describing an example of a method for deriving a template matching error according to an embodiment of the present disclosure. An example shown in FIG. 14 relates to a method for calculating the template matching error of an MMVD prediction candidate. According to FIG. 14, as a merge prediction motion candidate, the motion information of a decoded prediction block at a predefined position (e.g., left or above, etc.) may be used. According to an embodiment shown in FIG. 14, the motion information of a decoded prediction block located at a predefined position (e.g., left) may be used. More specifically, it is a diagram for describing an example of a case where motion information is derived by applying an MMVD offset to the motion information of a prediction block located at a predefined position (e.g., left). As an example, a template matching error may be expressed as a cost when describing an example of FIG. 14, and a corresponding cost may be derived based on a difference (error) value between the pixel value of the template area of a reference picture referenced by motion information (T^{r}) and the neighboring decoded pixel of a current block (T^{c}). In an example of FIG. 14, func( ) may be defined as various metrics such as SAD, MR-SAD (Mean-Reduced SAD), etc.

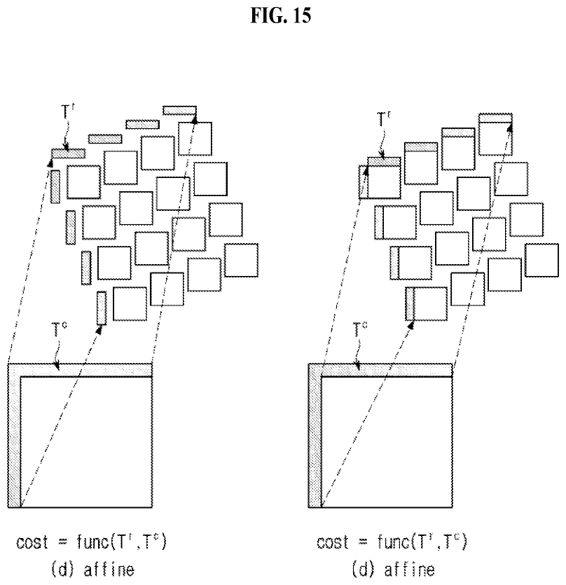

Meanwhile, FIG. 15 is a diagram for describing an example of a method for deriving a template matching error according to an embodiment of the present disclosure. More specifically, an example of FIG. 15 relates to a method for deriving the template matching error of an affine prediction candidate. As an example, a method for calculating the template matching error of an affine prediction candidate may be classified into two cases: a case in which an affine model illustrated on the left of FIG. 15 is applied by considering even a template area and a case in which an affine model illustrated on the right is applied to a current block area and an adjacent decoded pixel is used as a template area. Meanwhile, a matching error may be expressed as a cost when deriving a template matching error, and a corresponding cost may be derived based on a difference (error) value between the pixel value of the template area of a reference picture referenced by motion information (T^{r}) and the neighboring decoded pixel of a current block (T^{c}). Meanwhile, in FIG. 15, func( ) may be defined as various metrics such as SAD, MR-SAD (Mean-Reduced SAD), etc.

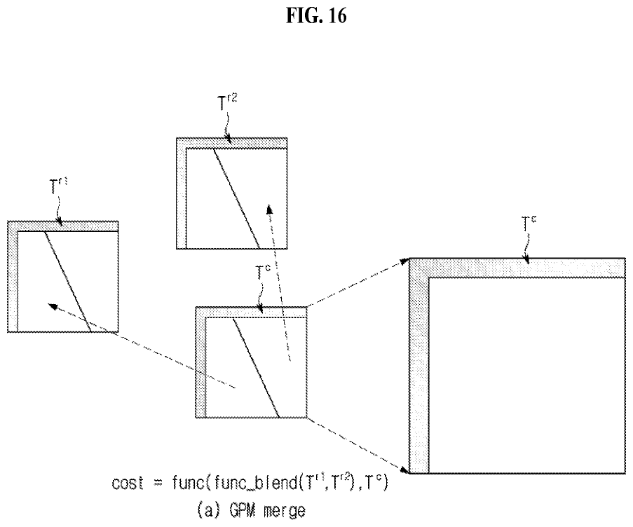

Meanwhile, FIG. 16 is a diagram for describing an example of a method for deriving a template matching error according to an embodiment of the present disclosure. More specifically, it is a diagram for describing an example of a method for deriving the template matching error of a GPM prediction candidate. According to an example of FIG. 16, there may be template areas corresponding to motion information for two areas ((T^{r1}), (T^{r2})), and a corresponding cost may be derived based on a difference (error) value between the pixel value of the template area of a reference picture referenced by motion information (TT) and the neighboring decoded pixel of a current block (T^{c}). In FIG. 16, func( ) may be defined as various metrics such as SAD, MR-SAD (Mean-Reduced SAD), etc. In addition, the Func_blend( ) function may be a function that derives a corresponding cost based on a weighted average value for the pixel values of template areas of a plurality of (e.g., two) inter prediction blocks.

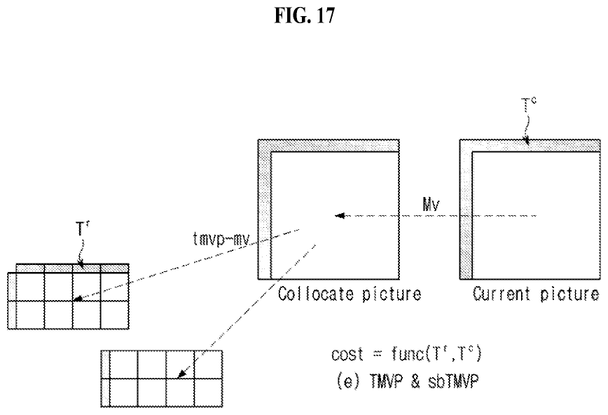

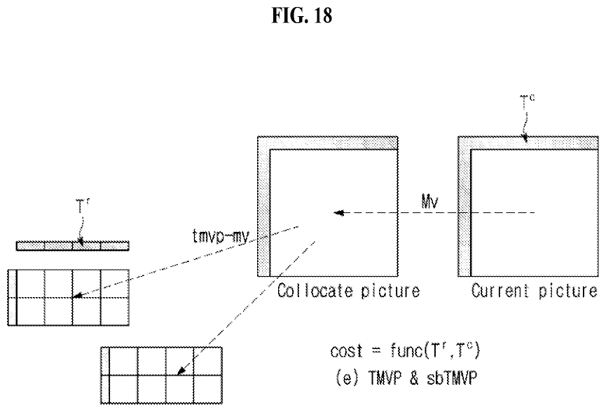

FIGS. 17 and 18 are a diagram for describing an example of a method for deriving a template matching error according to an embodiment of the present disclosure. More specifically, FIGS. 17 and 18 are a diagram for describing an example of a method for deriving the template matching error of a TMVP and/or sbTMVP prediction candidate. As an example, a method for deriving the template matching error of a proposed TMVP and/or sbTMVP prediction candidate may be largely classified into two. First, referring to FIG. 17, a case may occur in which a temporal motion vector (temporal MV) referenced in a collocated picture is applied to a current block area and an adjacent decoded pixel is used as a template area, or referring to FIG. 18, a case may occur in which a temporal motion vector (temporal MV) referenced in a collocated picture is applied by considering even a template area, and accordingly, a template matching error may be derived. As an example, here, a matching error may be expressed as a cost, and a corresponding cost may be derived based on a difference (error) value between the pixel value of the template area of a reference picture referenced by motion information (T^{r}) and the neighboring decoded pixel of a current block (T^{c}). In addition, in FIGS. 17 and 18, func( ) may be defined as various metrics such as SAD, MR-SAD (Mean-Reduced SAD), etc.

Meanwhile, when motion prediction candidates constructed into one list are ordered based on template similarity, information on a prediction candidate signaled in a bitstream (e.g., a prediction candidate index) may refer only to a prediction candidate corresponding to a predefined number, instead of being defined up to the total number of available candidate. In other words, for example, when it is assumed that the number of available prediction candidates is 30, instead of referring to prediction candidate indexes from 0 to 29, prediction candidate indexes may be referred to only from 0 to (N−1) by referring only up to a predefined number (N). In this case, a specific prediction candidate included in a prediction candidate list may not be selected.

Meanwhile, as an example, information on a prediction candidate list and/or a prediction candidate may be signaled as follows. Referring to Table 5 below, as an example, a modified signaling method for information on a modified prediction candidate list and/or prediction candidate is described. As an example, Table 5 may be an example modified based on an existing video codec standard (e.g., VVC).

Meanwhile, as an example, when only N predefined prediction candidates are referred to for the effective signaling of information on a prediction candidate (e.g., a prediction candidate index described above, etc.), binarization may be performed by using integers N and M as shown in Table 6 below.

TABLE 6

| Syntax | | Binarization | |
|---|---|---|---|
| structure | Syntax element | Process | Input parameters |
| merge_data( ) | generalized_merge_{—} | TR | cMax = N, cRiceParam = M |
| | candidate_idx[ ][ ] | | |

Meanwhile, since a syntax name of generalized_merge_candidate_idx is arbitrarily designated for clarity when describing an embodiment of the present disclosure, it is obvious that other names may also be used and are included in the present disclosure. As an example, a method for generating a generalized (i.e., complex) merge candidate list proposed in the present disclosure may be classified as a separate prediction mode. For example, when a conventional video codec standard (e.g., VVC) is used as an example, the embodiments of the present disclosure do not substitute a conventional prediction candidate construction process, but in order to define a prediction candidate with shorter bits, a syntax may also be signaled as shown in Table 7 below.

TABLE 7

| | Descriptor |
|---|---|
| merge_data( x0, y0, cbWidth, cbHeight, cbType ) { | |
| if( CuProdMode[ sbType ][ x0 ][ y0 ] [symbol] MODE_ [symbol] BC ) { | |
| if( MaxN [symbol] m [symbol] b [symbol] MergeCand > 1 ) | |
| merge_idx[ x0 ][ y0 ] | [symbol] ( [symbol] ) |
| } else { | |
| generalized_merge_flag[ x0 ][ y0 ] | [symbol] ( [symbol] ) |
| if(generalized_merge_flag[ x0 ][ y0 ]) { | |
| generalized_merge_candidate_idx[ x0 ][ y0 ] | [symbol] ( [symbol] ) |
| }else{ | |
| if( MaxNumSubblockMergeCand > 0 && sbWidth [symbol] 8 && cbHeight [symbol] 8 ) | |
| merge_subblock_flag[ x0 ][ y0 ] | [symbol] ( [symbol] ) |
| if( merge_subblock_flag[ x0 ][ y0 ] [symbol] ) { | |
| if( MaxN [symbol] SubblockMergeCand [symbol] 1 ) | |
| merge_subblock_idx[ x0 ][ y0 ] | [symbol] ( [symbol] ) |
| } else { | |
| if( cbWidth [symbol] 128 && cbHeight [symbol] 128 && | |
| ( [symbol] sp [symbol] _c [symbol] p_enabled_flag && cu_skip_flag[ x0 ][ y0 ] = = 0 && | |
| (cbWidth [symbol] cbHeight ) > [symbol] 64 ) [symbol] | |
| [symbol] sp [symbol] _ [symbol] _enabled_flag && | |
| [symbol] _ [symbol] _type [symbol] && cbWidth [symbol] 8 && cbHeight [symbol] 8 && | |
| cbWidth<( 8 [symbol] cbHeight ) && cbHeight<( 8 [symbol] cbHeight ) [symbol] | |
| regular_merge_flag[ x0 ][ y0 ] | [symbol] ( [symbol] ) |
| if( regular_merge_flag[ x0 ][ y0 ] = = 1 ) [symbol] | |
| if( sp [symbol] _ [symbol] _enabled_flag ) | |
| [symbol] _merge_flag[ x0 ][ y0 ] | [symbol] ( [symbol] ) |
| if( [symbol] _merge_flag[ x0 ][ y0 ] = = 1 ) [symbol] | |
| if( MaxN [symbol] MergeCand > 1 ) | |
| [symbol] d_cand_flag[ x0 ][ y0 ] | [symbol] ( [symbol] ) |
| [symbol] d_distance_idx[ x0 ][ y0 ] | [symbol] ( [symbol] ) |
| [symbol] d_direction_idx[ x0 ][ y0 ] | [symbol] ( [symbol] ) |
| [symbol] else if( MaxN [symbol] MergeCand > 1 ) | |
| merge_idx[ x0 ][ y0 ] | [symbol] ( [symbol] ) |
| } else { | |
| if( sps_ [symbol] _enabled_flag && sps_ [symbol] _enabled_flag && | |
| [symbol] _ [symbol] _type = = [symbol] && | |
| cu_ski [symbol] _flag[ x0 ][ y0 ] = = 0 && cbWidth [symbol] && cbHeight [symbol] && | |
| cbWidth < ( 8 [symbol] cbHeight ) && cbHeight < ( 8 [symbol] cbWidth ) && | |
| cbWidth < 128 && cbHeight [symbol] 128 ) | |
| ciip_flag[ x0 ][ y0 ] | [symbol] ( [symbol] ) |
| if( ciip_flag[ x0 ][ y0 ] && MaxNumMergeCand > 1 ) | |
| merge_idx[ x0 ][ y0 ] | [symbol] ( [symbol] ) |
| if( ciip_flag[ x0 ][ y0 ]) [symbol] | |
| merge_ [symbol] _partition_idx[ x0 ][ y0 ] | [symbol] ( [symbol] ) |
| merge_ [symbol] _idx0[ x0 ][ y0 ] | [symbol] ( [symbol] ) |
| if( MaxN [symbol] MergeCand [symbol] 2 ) | |
| merge_ [symbol] _idx1[ x0 ][ y0 ] | [symbol] ( [symbol] ) |
| } | |
| } | |
| } | |
| } | |
| } | |
| } | |

[symbol]

indicates data missing or illegible when filed

As an example, when the value of a generalized_merge_flag[x0][y0] syntax is 1, it may mean that a single merge list including a regular merge mode, an MMVD mode and a CHIP prediction mode is applied to a current coding unit. In this case, a subblock-based inter prediction parameter for a current coding unit may be inferred from neighboring blocks or may be generated based on geometric partition-based inter prediction. Meanwhile, array index x0, y0 may be variables for designating the top-left luma sample position (x0, y0) of a coding block considered based on the top-left luma sample of a picture. Meanwhile, when the value of a corresponding syntax is 0, it may represent that a single merge list described above is not applied to a current coding unit. (generalized_merge_flag[x0][y0] equal to 1 specifies that single merge list which contains regular merge mode, merge mode with motion vector difference, combined inter-picture merge and intra-picture prediction is applied for the current coding unit, subblock-based inter prediction parameters for the current coding unit are inferred from neighbouring blocks or geometric partition-based inter prediction is used to generate the inter prediction parameters of the current coding unit. The array indices x0, y0 specify the location (x0, y0) of the top-left luma sample of the considered coding block relative to the top-left luma sample of the picture).

As an example, generalized_merge_candidate_idx [x0][y0] may be the merge candidate index of a generalized (i.e., merge) merge candidate list described above, i.e., a prediction candidate index. Here, x0, y0 may designate the position (x0, y0) of the top-left luma sample of a coding block considered based on the top-left luma sample of a picture. (generalized_merge_candidate_idx [x0][y0] specifies the merging candidate index of the generalized merging candidate list where x0, y0 specify the location (x0, y0) of the top-left luma sample of the considered coding block relative to the top-left luma sample of the picture).

In addition, when only N predefined prediction candidates are referred to for the effective signaling of information on a prediction candidate (e.g., a prediction candidate index, etc.), binarization may be performed by using integers N and M as follows.

TABLE 8

| Syntax | | Binarization | |
|---|---|---|---|
| structure | Syntax element | Process | Input parameters |
| merge_data( ) | regular_merge_flag[ ][ ] | FL | cMax = 1 |
| | generalized_merge_{—} | TR | cMax = N, cRiceParam = M |
| | candidate_idx[ ][ ] | | |

Meanwhile, as an example, a residual signal may not be signaled based on a generalized merge candidate list proposed above. Meanwhile, this embodiment may be applied only when the value of cu_skip_flag is 1, meaning that the residual signal of a current block is not transmitted to a bitstream as shown in Table 9 below.

TABLE 9

| | Descriptor |
|---|---|
| merge_data( x0, y0, cbWidth, cbHeight, cbType ) { | |
| if( CuProdMode[ [symbol] Type ][ x0 ][ y0 ] [symbol] MODE_ [symbol] BC ) { | |
| if( MaxN [symbol] m [symbol] b [symbol] MergeCand > 1 ) | |
| merge_idx[ x0 ][ y0 ] | [symbol] ( [symbol] ) |
| } else { | |
| if(cu_skip_flag[ x0 ][ y0 ]) { | |
| generalized_merge_flag[ x0 ][ y0 ] | [symbol] ( [symbol] ) |
| if(generalized_merge_flag[ x0 ][ y0 ]) { | |
| generalized_merge_candidate_idx[ x0 ][ y0 ] | [symbol] ( [symbol] ) |
| } | |
| } | |
| if( MaxNumSubblockMergeCand > 0 && cbWidth [symbol] && cbHeight [symbol] 8 ) | |
| merge_subblock_flag[ x0 ][ y0 ] | [symbol] ( [symbol] ) |
| if( merge_subblock_flag[ x0 ][ y0 ] [symbol] 1 ) { | |
| if( MaxNumSubblockMergeCand [symbol] 1 ) | |
| merge_subblock_idx[ x0 ][ y0 ] | [symbol] ( [symbol] ) |
| } else { | |
| if( cbWidth < 128 && cbHeight < 128 && | |
| (( sps_ciip_enabled_flag && cu_skip_flag[ x0 ][ y0 ] = = 0 && | |
| ( cbWidth [symbol] cbHeight ) [symbol] 64 ) [symbol] | |
| ( sps_gpm_enabled_flag && | |
| s [symbol] _slice_type [symbol] && cbWidth [symbol] && cbHeight [symbol] 8 && | |
| cbWidth < ( 8 [symbol] cbHeight ) && cbHeight < ( 8 [symbol] cbHeight [symbol] | |
| regular_merge_flag[ x0 ][ y0 ] | [symbol] ( [symbol] ) |
| if( regular_merge_flag[ x0 ][ y0 ] = = 1 ) [symbol] | |
| if( sps_ [symbol] d_enabled_flag ) | |
| [symbol] _merge_flag[ x0 ][ y0 ] | [symbol] ( [symbol] ) |
| if( [symbol] d_merge_flag[ x0 ][ y0 ] = = 1 ) [symbol] | |
| if( MaxNumMergeCand > 1 ) | |
| [symbol] d_cand_flag[ x0 ][ y0 ] | [symbol] ( [symbol] ) |
| [symbol] d_distance_idx[ x0 ][ y0 ] | [symbol] ( [symbol] ) |
| [symbol] d_direction_idx[ x0 ][ y0 ] | [symbol] ( [symbol] ) |
| [symbol] else if( MaxN [symbol] MergeCand > 1 ) | |
| merge_idx[ x0 ][ y0 ] | [symbol] ( [symbol] ) |
| } else { | |
| if( sps_c [symbol] p_enabled_flag && sps_ [symbol] _enabled_flag && | |
| [symbol] _ [symbol] _type = = [symbol] && | |
| cu_skip_flag[ x0 ][ y0 ] = = 0 && cbWidth [symbol] && cbHeight [symbol] && | |
| cbWidth < ( 8 [symbol] cbHeight ) && cbHeight < ( 8 [symbol] cbWidth ) && | |
| cbWidth < 128 && cbHeight [symbol] 128 ) | |
| ciip_flag[ x0 ][ y0 ] | [symbol] ( [symbol] ) |
| if( ciip_flag[ x0 ][ y0 ] && MaxNumMergeCand > 1 ) | |
| merge_idx[ x0 ][ y0 ] | [symbol] ( [symbol] ) |
| if( [symbol] ciip_flag[ x0 ][ y0 ]) [symbol] | |
| merge_ [symbol] _partition_idx[ x0 ][ y0 ] | [symbol] ( [symbol] ) |
| merge_ [symbol] _idx0[ x0 ][ y0 ] | [symbol] ( [symbol] ) |
| if( MaxN [symbol] MergeCand [symbol] 2 ) | |
| merge_ [symbol] _idx1[ x0 ][ y0 ] | [symbol] ( [symbol] ) |
| } | |
| } | |
| } | |
| } | |
| [symbol] | |

[symbol]

indicates data missing or illegible when filed

In Table 9 above, cu_skip_flag may be information decoded before a proposed syntax or may be information signaled in a bitstream. As an example, when the value of cu_skip_flag[x0][y0] is 1, it may represent that when decoding slice P or B for a current coding unit, after cu_skip_flag, there is no further parsed syntax element other than an IBC mode flag pred_mode_ibc_flag[x0][y0] and/or a merge_data( ) syntax structure. Meanwhile, when decoding slice I, based on the value of the syntax, it may represent that there is no syntax element parsed after cu_skip_flag[x0][y0] other than merge_idx [x0][y0]. Meanwhile, when the value of cu_skip_flag[x0][y0] is 0, it may represent that a coding unit is not skipped. Meanwhile, array index x0, y0 may designate the top-left luma sample position (x0, y0) of a coding block considered based on the top-left luma sample of a picture. (cu_skip_flag[x0][y0] equal to 1 specifies that for the current coding unit, when decoding a P or B slice, no more syntax elements except one or more of the following are parsed after cu_skip_flag[x0][y0]: the IBC mode flag pred_mode_ibc_flag[x0][y0], and the merge_data( ) syntax structure; when decoding an I slice, no more syntax elements except merge_idx [x0][y0] are parsed after cu_skip_flag[x0][y0]. cu_skip_flag[x0][y0] equal to 0 specifies that the coding unit is not skipped. The array indices x0, y0 specify the location (x0, y0) of the top-left luma sample of the considered coding block relative to the top-left luma sample of the picture).

In Table 9 above, information on a generalized merge candidate list and/or prediction candidate, etc. proposed in the embodiment of the present disclosure may be signaled based on the value of cu_skip_flag.

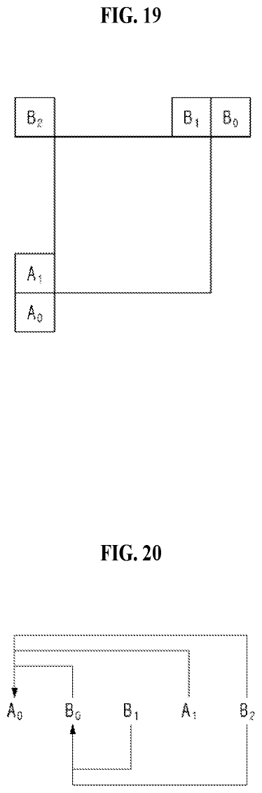

Meanwhile, the following embodiment describes a generalized merge prediction candidate construction process described above by referring to FIGS. 19 to 22. According to embodiments referring to FIGS. 19 to 22, a prediction candidate with various characteristics may be constructed into one list, and the construction order of prediction candidates constructing a list, the number of prediction candidates, etc. may affect performance. For this reason, as an embodiment, as many prediction candidates as a number predefined in a decoder or a number defined in a bitstream may be added to a list by iterating over some or all of the various prediction candidates including the following merge prediction candidates. As an example, the types of prediction candidates added in a list may be as follows.
1. A of the multiple motion information (spatial candidates) derived from a neighboring decoded block
2. B of the multiple motion information derived from a block not neighboring a current block among the neighboring decoded blocks
3. C of the multiple motion information (temporal candidates) derived from a pre-decoded reference picture
4. D of the multiple motion information (ex. HMVP) derived from motion information stored in a lookup table
5. E of the multiple motion information derived as a combination of motion information of two or more prediction candidates
6. F of the multiple motion (MMVD) information compensating MVD
7. G of the multiple motion information derived from an affine model
8. H of the motion information derived from a decoder through template matching
9. I of the intraTMP prediction candidates
10. J of the IBC prediction candidates
11. K of the candidates (CIIP) that generate a prediction block by combining motion information and intra prediction information
12. L of the prediction candidates that generate a non-forward prediction block (GPM)
13. M of the candidates that generate a prediction block with three or more motion information, i.e., multi-hypothesis predictions

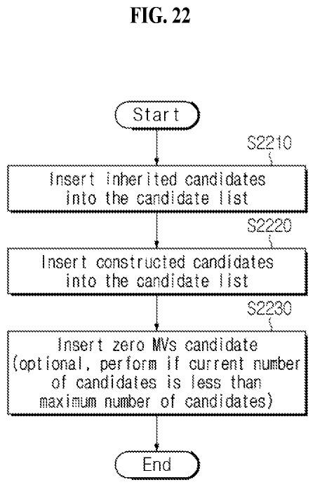

Each prediction candidate above may be included in a prediction candidate list, and when constructing a prediction candidate list based on each prediction candidate, as an example, it may be performed in order illustrated in FIG. 22. According to FIG. 22, inherited candidates may be included in a generalized prediction candidate list described above S2210, and then constructed candidates may be included in a corresponding candidate list S2220. Afterwards, when the current number of candidates is less than the maximum number of candidates, zero MV candidates may be optionally included in a list S2230. In this case, when deriving an arbitrary number of prediction candidates in each manner, prediction candidates are derived according to a priority, but it is also possible to add a candidate by iterating over all candidates that may be derived or iterating over only a part of the entire candidates. In addition, when a predefined number of candidates are added, it may proceed to the process of constructing a prediction candidate with different characteristics. In other words, when A candidates are added to the table of contents 1 above, B candidates in the table of contents 2 may be included in a list, but a candidate in the table of contents 2 to 13 may also be included after only a part, not all of the A are included.

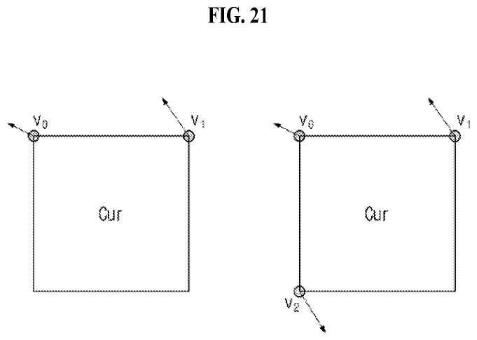

For example, it is assumed that spatial candidate 1 above and affine prediction candidate 7 are included in a list in the process of constructing a generalized merge candidate list according to an embodiment of the present disclosure described above. In this case, it is assumed that a spatial candidate may refer to motion information at a position in FIG. 19 and follows the order in FIG. 20. If it is determined to include two spatial candidates when constructing a generalized merge prediction candidate, the process of constructing two or more prediction candidates by iterating over the order illustrated in FIG. 20 and constructing an affine prediction candidate in FIG. 21 without further construction if two prediction candidates are constructed may be performed. As an example, when an affine prediction candidate construction process follows the same order, all prediction candidates may be added. However, only some prediction candidates may be added, and a predefined number of affine prediction candidates may be added to a generalized prediction candidate list. Since it corresponds to an embodiment of the present disclosure, other prediction candidates may be added.

Meanwhile, as an example, the prediction candidate that may be included in a generalized prediction candidate list may be included in the predetermined order of addition to a prediction candidate list. For example, it may be performed in the order of adding an affine candidate to a list, adding an MMVD candidate, adding a GPM candidate, etc. or may be defined in the order of adding an MMVD candidate, adding an affine candidate, adding a GPM candidate, etc. In other words, a prediction candidate list may be constructed in the predefined order, and other prediction candidates may be further included other than the table of contents 1 to 13 described above, and when a prediction candidate is added, it may be included in a list according to a method for determining a specific priority.

The embodiment of the present disclosure relates to an image/video coding method and apparatus, and more specifically, relates to the process of deriving motion information during an inter prediction process and generating a prediction block based on derived motion information. The embodiment of the present disclosure may propose a prediction candidate list including a prediction candidate constructed with the motion information of different characteristics, a method for determining the order of a corresponding prediction candidate list and a method for calculating an error value that may serve as a reference for list reordering, thereby refining compression efficiency while minimizing the amount of transmitted bits.

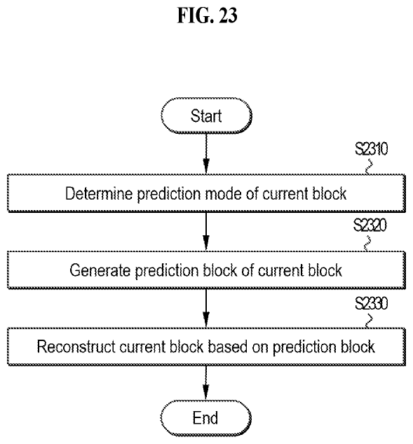

FIG. 23 relates to an image decoding method that may be performed by an image decoding apparatus according to an embodiment of the present disclosure. As an example, since the embodiment of FIG. 23 may be based on an embodiment described above, an overlapping part with a part described above is omitted.

As an example, according to an image decoding method performed by an image decoding apparatus in FIG. 23, the prediction mode of a current block may be determined S2310. As an example, the prediction mode of a current block may be determined based on prediction mode information, and prediction mode information may represent whether an inter prediction mode or an intra prediction mode, etc. is applied. As an example, prediction mode information may be signaled in a bitstream. Since it is the same as described above, an overlapping description is omitted.

Afterwards, the inter prediction block of a current block may be generated based on the prediction mode of a current block being an inter prediction mode S2320, and a current block may be reconstructed based on a generated inter prediction block S2330. As an example, an inter prediction block may be generated based on the prediction candidate of a prediction candidate list, and a prediction candidate list may include at least two of a merge prediction candidate, a merge with motion vector difference (MMVD) prediction candidate, combined inter-intra prediction (CIIP), multi-hypothesis prediction, affine merge, subblock-based temporal motion vector prediction (SbTMVP) or a geometric partitioning mode (GPM) merge prediction candidate. A prediction candidate derived in various ways may be included in one prediction candidate list. The description of each prediction candidate is the same as described above, so an overlapping description is omitted. Meanwhile, as an example, a prediction candidate list may be a generalized (i.e., complex) prediction candidate list described above, a prediction candidate list may be derived based on a prediction candidate list usage flag, and a prediction candidate list usage flag may be proposed_generalized_merge_flag as described above or may be information signaled in a bitstream. A description thereof is the same as described above, so an overlapping description is omitted. In addition, specific information may be derived to select a prediction candidate included in a prediction candidate list. As an example, a prediction candidate may be selected based on a prediction candidate index, and a prediction candidate index may be merge_idx as described above or may be information signaled in a bitstream. A description thereof is the same as described above, so an overlapping description is omitted. In addition, the prediction candidate of a prediction candidate list may be ordered according to an error value derived based on a difference value between the pixel value of the template area of a reference picture and the neighboring pixel of the current block. In this case, an embodiment for determining a priority described above may be applied, so an overlapping description is omitted. Meanwhile, an error value may be derived based on at least one of the sum of absolute difference (SAD) or the mean-reduced SAD (MR-SAD). In addition, based on a CIIP prediction candidate being included in a prediction candidate list, an error value for a CIIP prediction candidate may be derived based on a value obtained by weighted averaging the pixel value of a template area derived by using an intra prediction method and the pixel value of the template area of a reference picture. In addition, based on a GPM prediction candidate being included in a prediction candidate list, an error value for a GPM prediction candidate may be derived based on a value obtained by weighted averaging pixel values of template areas of a plurality of inter prediction blocks. It is the same as described by referring to FIGS. 12 to 22, so an overlapping description is omitted.

Meanwhile, since FIG. 23 corresponds to an embodiment of the present disclosure, the order of some steps may be changed or some steps may be added or may not be performed, which is also obviously included in the scope of the present disclosure.

Meanwhile, as another example, FIG. 23 may be included in an image encoding method performed by an image encoding apparatus. In other words, FIG. 23 may be an example of an image encoding method performed by an image encoding apparatus.

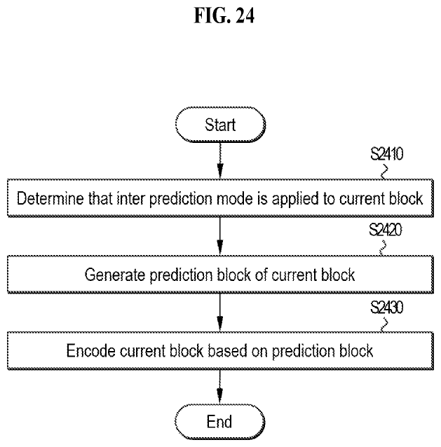

FIG. 24 relates to an image encoding method that may be performed by an image encoding apparatus according to an embodiment of the present disclosure. As an example, since the embodiment of FIG. 24 may be based on an embodiment described above, an overlapping part with a part described above will be omitted.

As an example, according to an image encoding method performed by an image encoding apparatus in FIG. 24, the prediction mode of a current block may be determined S2410. When a prediction mode is determined as an inter prediction mode, the prediction block of a current block may be generated based on a determined inter prediction mode S2420. Here, a generated prediction block may be an inter prediction block, and a current block may be encoded based on a generated prediction block S2430. As an example, a prediction block may be generated based on the prediction candidate of a prediction candidate list, and a prediction candidate list may include at least two of a merge prediction candidate, a merge with motion vector difference (MMVD) prediction candidate, combined inter-intra prediction (CIIP), multi-hypothesis prediction, affine merge, subblock-based temporal motion vector prediction (SbTMVP) or a geometric partitioning mode (GPM) merge prediction candidate. A prediction candidate derived in various ways may be included in one prediction candidate list. Meanwhile, as an example, a prediction candidate list may be a generalized (i.e., complex) prediction candidate list described above, and a prediction candidate list may be derived based on a prediction candidate list being determined to be used. In addition, a prediction candidate list usage flag may be proposed _generalized_merge_flag as described above or may also be information encoded and signaled in a bitstream. A description thereof is the same as described above, so an overlapping description is omitted. In addition, information necessary to specify a prediction candidate selected among the prediction candidates included in a prediction candidate list may be encoded and signaled in a bitstream. As an example, a prediction candidate may be selected based on a prediction candidate index, and a prediction candidate index may be merge_idx as described above or may be information signaled in a bitstream. A description thereof is the same as described above, so an overlapping description is omitted. In addition, the prediction candidate of a prediction candidate list may be ordered according to an error value derived based on a difference value between the pixel value of the template area of a reference picture and the neighboring pixel of a current block. In this case, an embodiment for determining a priority described above may be applied, so an overlapping description is omitted. Meanwhile, an error value may be derived based on at least one of the sum of absolute difference (SAD) or the mean-reduced SAD (MR-SAD). In addition, based on a CIIP prediction candidate being included in a prediction candidate list, an error value for a CIIP prediction candidate may be derived based on a value obtained by weighted averaging the pixel value of a template area derived by using an intra prediction method and the pixel value of the template area of a reference picture. In addition, based on a GPM prediction candidate being included in a prediction candidate list, an error value for a GPM prediction candidate may be derived based on a value obtained by weighted averaging pixel values of template areas of a plurality of inter prediction blocks. It is the same as described by referring to FIGS. 12 to 22, so an overlapping description is omitted. In addition, a current block may be encoded by using a residual block derived based on a prediction block, which is the same as described above, so an overlapping description is omitted.

Meanwhile, information on a prediction candidate list may be encoded and signaled in a bitstream, a prediction candidate list usage flag and/or a prediction candidate index may be included in information on a prediction candidate list and a prediction candidate index may be encoded and signaled in a bitstream based on a prediction candidate list usage flag.

Meanwhile, as an example, a bitstream generated by an image encoding method may be transmitted from one apparatus to another apparatus (e.g., from an encoder to a decoder) or may be recorded or stored on a computer-readable medium. Accordingly, an apparatus and method for transmitting and/or a medium for recording/storing a bitstream generated by an image encoding method are also included in the embodiment of the present disclosure.

Meanwhile, since FIG. 24 corresponds to an embodiment of the present disclosure, the order of some steps may be changed or some steps may be added or may not be performed, which is also obviously included in the scope of the present disclosure.

Although the exemplary methods of the present disclosure are expressed as a series of operations for clarity of description, this is not intended to limit the order in which steps are performed, and if necessary, each step may be performed simultaneously or in different order. In order to implement a method according to the present disclosure, another step may be additionally included in an exemplary step or the remaining steps may be included excluding some steps or another additional step may be included excluding some steps.

In the present disclosure, an image encoding device or an image decoding device performing a predetermined operation (step) may perform an operation (a step) for checking a condition or a situation for performing a corresponding operation (step). For example, when it is stated that a predetermined operation is performed when a predetermined condition is satisfied, an image encoding device or an image decoding device may perform an operation for checking whether the predetermined condition is satisfied, and then perform the predetermined operation.

The various embodiments of the present disclosure do not list all possible combinations, but are intended to describe the representative aspect of the present disclosure, and matters described in various embodiments may be applied independently or in a combination of at least two.

In addition, the various embodiments of the present disclosure may be implemented by hardware, firmware, software or a combination thereof. For implementation by hardware, they may be implemented by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), general processors, controllers, microcontrollers, microprocessors, etc.

In addition, an image decoding device and an image encoding device to which an embodiment of the present disclosure is applied may be included in a multimedia broadcasting transmitting and receiving device, a mobile communication terminal, a home cinema video device, a digital cinema video device, a surveillance camera, a video communication device, a real-time communication device such as a video communication, a mobile streaming device, a storage medium, a camcorder, a video-on-demand (VOD) service providing device, an OTT video (Over the top video) device, an Internet streaming service providing device, a three-dimensional (3D) video device, a video phone video device, a medical video device, etc., and may be used to process a video signal or a data signal. For example, an OTT video (Over the top video) device may include a game console, a Blu-ray player, an Internet-connected TV, a home theater system, a smartphone, a tablet PC, a digital video recorder (DVR), etc.

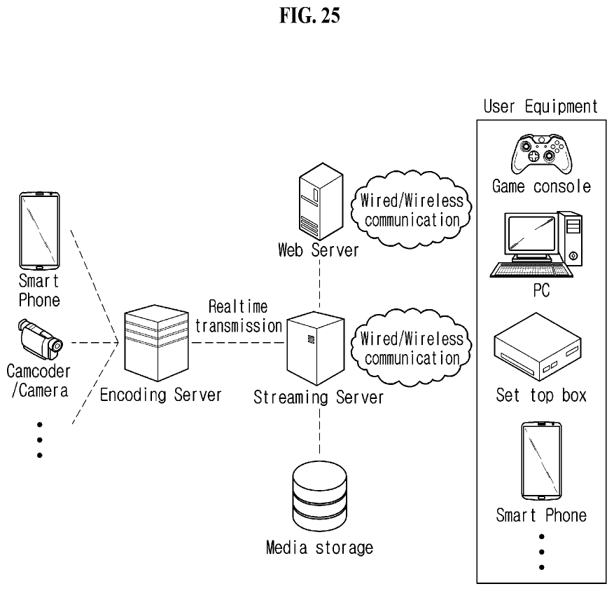

FIG. 25 shows an exemplary diagram of a content streaming system to which an embodiment of the present disclosure may be applied.

As shown in FIG. 25, the content streaming system to which an embodiment of the present disclosure is applied may broadly include an encoding server, a streaming server, a web server, a media storage, a user device, and a multimedia input device.

The encoding server compresses content input from multimedia input devices such as a smartphone, camera, or camcorder into digital data, generating a bitstream and transmitting it to the streaming server. As another example, when multimedia input devices such as a smartphone, camera, or camcorder directly generate a bitstream, the encoding server may be omitted.

The bitstream may be generated by the video encoding method and/or the image encoding apparatus to which an embodiment of the present disclosure is applied, and the streaming server may temporarily store the bitstream during the process of transmitting or receiving the bitstream.

The streaming server may transmit multimedia data to a user device based on a user request through the web server, and the web server may serve as an intermediary that informs user of available service. When a user requests a desired service from the web server, the web server may send the request to the streaming server, and the streaming server may transmit the multimedia data to the user. In this case, the content streaming system may include a separate control server, and in this case, a control server may function to control command/response exchanges between devices within the content streaming system.

The streaming server may receive content from a media storage and/or an encoding server. For example, when receiving content from the encoding server, the content may be received in real time. In this case, to provide a seamless streaming service, the streaming server may store the bitstream for a certain period of time.

Examples of the user device may include a mobile phone, a smartphone, a laptop computer, a digital broadcasting terminal, a personal digital assistant (PDA), a portable multimedia player (PMP), a navigation device, a slate PC, a tablet PC, an ultrabook, a wearable device (i.e., a smartwatch, a smart glass, a head-mounted display (HMD)), a digital TV, a desktop computer, and digital signage.

Each server within the content streaming system may be operated as a distributed server, in which case the data received by each server may be processed in a distributed manner.

The range of the present disclosure includes software or machine-executable instructions (i.e., an operating system, an application, firmware, a program, etc.) that enable operations according to the methods of various embodiments to be executed on a device or computer, and a non-transitory computer-readable medium in which such software or instructions are stored and executable on a device or computer.

### INDUSTRIAL APPLICABILITY

The embodiments of the present disclosure may be used for encoding/decoding an image.

1. An image decoding method performed by an image decoding apparatus, comprising:
determining a prediction mode of a current block;
generating an inter prediction block of the current block based on the prediction mode of the current block being an inter prediction mode; and
reconstructing the current block based on the inter prediction block,
wherein the inter prediction block is generated based on a prediction candidate of a prediction candidate list, and
wherein the prediction candidate list includes at least two prediction candidates among a merge prediction candidate, a merge with motion vector difference (MMVD) prediction candidate, combined inter-intra prediction (CIIP), multi-hypothesis prediction, affine merge, subblock-based temporal motion vector prediction (SbTMVP), or a geometric partitioning mode (GPM) merge prediction candidate.

2. The method of claim 1, wherein the prediction candidate list is derived based on a prediction candidate list usage flag.

3. The method of claim 2, wherein the prediction candidate list usage flag is obtained from a bitstream.

4. The method of claim 1, wherein the prediction candidate is selected based on a prediction candidate index.

5. The method of claim 4, wherein the prediction candidate index is signaled from a bitstream.

6. The method of claim 1, wherein the prediction candidate of the prediction candidate list is ordered according to an error value derived based on a difference value between a pixel value of a template area of a reference picture and a neighboring pixel of the current block.

7. The method of claim 6, wherein the error value is derived based on at least one of a sum of absolute difference (SAD) or a mean-reduced SAD (MR-SAD).

8. The method of claim 6, wherein based on the CIIP prediction candidate being included in the prediction candidate list, an error value for the CIIP prediction candidate is derived based on a value obtained by weighted averaging a pixel value of a template area derived by using an intra prediction method and a pixel value of a template area of a reference picture.

9. The method of claim 6, wherein based on the GPM prediction candidate being included in the prediction candidate list, an error value for the GPM prediction candidate is derived based on a value obtained by weighted averaging pixel values of template areas of a plurality of inter prediction blocks.

10. An image encoding method performed by an image encoding apparatus, comprising:
determining a prediction mode of a current block as an inter prediction mode;
generating a prediction block of the current block based on the inter prediction mode; and
reconstructing the current block based on the prediction block,
wherein the prediction block is generated based on a prediction candidate of a prediction candidate list, and
wherein the prediction candidate list includes at least two prediction candidates among a merge prediction candidate, a merge with motion vector difference (MMVD) prediction candidate, combined inter-intra prediction (CIIP), multi-hypothesis prediction, affine merge, subblock-based temporal motion vector prediction (SbTMVP), or a geometric partitioning mode (GPM) merge prediction candidate.

11. The method of claim 10, wherein information on the prediction candidate list is encoded into a bitstream.

12. The method of claim 11, wherein the information on the prediction candidate list includes a prediction candidate list usage flag and a prediction candidate index.

13. A computer-readable medium storing a bitstream generated by an image encoding method, the image encoding method comprising:
determining a prediction mode of a current block as an inter prediction mode;
generating a prediction block of the current block based on the inter prediction mode; and
reconstructing the current block based on the prediction block,
wherein the prediction block is generated based on a prediction candidate of a prediction candidate list, and
wherein the prediction candidate list includes at least two prediction candidates among a merge prediction candidate, a merge with motion vector difference (MMVD) prediction candidate, combined inter-intra prediction (CIIP), multi-hypothesis prediction, affine merge, subblock-based temporal motion vector prediction (SbTMVP), or a geometric partitioning mode (GPM) merge prediction candidate.

14. A method for transmitting a bitstream generated by an image encoding method, the image encoding method comprising:
determining a prediction mode of a current block as an inter prediction mode;
generating a prediction block of the current block based on the inter prediction mode; and
reconstructing the current block based on the prediction block,
wherein the prediction block is generated based on a prediction candidate of a prediction candidate list, and
wherein the prediction candidate list includes at least two prediction candidates among a merge prediction candidate, a merge with motion vector difference (MMVD) prediction candidate, combined inter-intra prediction (CIIP), multi-hypothesis prediction, affine merge, subblock-based temporal motion vector prediction (SbTMVP), or a geometric partitioning mode (GPM) merge prediction candidate.
